(19) United States
(12) Patent Application Publication
(10) Pub. No.: US 2021/0047585 A1
(43) Pub. Date: Feb. 18, 2021

(54) Fexible Inline Pilaster Wick

(71) Applicant: John Edward Ramirez, Redding, CA (US)

(72) Inventor: John Edward Ramirez, Redding, CA (US)

(21) Appl. No.: 16/991,964

(22) Filed: Aug. 12, 2020

Related U.S. Application Data
(60) Provisional application No. 62/885,558, filed on Aug. 12, 2019.

(51) Int. Cl. C11C 5/00

(52) U.S. Cl. CPC C11C 5/006

(57) ABSTRACT

A candle wick includes at least a first layer of pilasters, and a second layer of soft body wick material, the first layer of pilasters adhered or otherwise attached to the wick body, the pilasters parallel, spaced apart, and attached or adhered orthogonally to the longitudinal axis of the wick body. In one embodiment the candle wick further includes a third pilaster layer opposing the first pilaster layer on the side of the wick body layer opposite the first layer of pilasters, wherein the individual pilasters are spaced in matching patterns.

### CROSS-REFERENCE TO RELATED DOCUMENTS

The present invention claims priority to a US. Provisional patent application entitled “Flexible Inline Pilaster Wick” Ser. No. 62/885,558 filed on Aug. 12, 2019, disclosure of which is included herein at least by reference.

### BACKGROUND OF THE INVENTION

### 1. Field of the Invention

The present invention relates generally to wicks and candles. More specifically, the present invention relates to a candle wick that includes parallel pilasters distributed across a flexible wick body and allows a user to control the height of the candle flame through adjustment of the spacing between the pilasters. The present invention can be molded, formed into various shapes the user desires, and built into a free-standing candle with or without a container.

### 2. Discussion of the State of the Art

A candle wick conducts fuel, such as melted candle wax, to a candle flame. When the candle wick is lit, the heat of the flame melts the wax surrounding the wick. The liquid wax is then drawn up the wick by capillary action. Additionally, the heat of the flame vaporizes the liquid wax, turns it into a hot gas, and starts to break down the hydrocarbons of the wax into molecules of hydrogen and carbon. The hydrogen and carbon molecules are then drawn up into the flame, where they react with oxygen from the air to create heat, light, water vapor (H₂O), and carbon dioxide (CO₂). Some heat radiates back and melts more wax to keep the combustion process going until the fuel is used up or the heat is eliminated.

Most wicks comprise a bundle of fibers that are twisted, braided, or knitted together. These fibers absorb the liquefied wax and carry it to the flame by capillary action. Selecting the correct wick is critical to making a candle that burns cleanly and properly. Wicks can be made of absorbent materials or materials with sufficient capillary action. The wick and its characteristics significantly influence how the candle burns.

Existing designs of elongated flame wicks have produced inconsistent performance in relation to flame height, width, and burn duration due to inconsistent manufacturing methods and wick materials. Additionally, they are difficult to bend and hold shape without a special forming process. Some elongated flame wick designs have been made of wood veneer that has inconsistent material properties due to natural variations of moisture content, cellulose pocket, grain, and pitch; thus, the wood veneer based elongated wick is difficult to shape without cracking or breaking apart the wick material. A special manufacturing process is required to hold a formed shape of the elongated wooden wick without breakage. Another existing design of the elongated flame wick is made of cardboard with perforated holes. This design is flawed mainly due to the inability to control the manufacturing process to meet the specifications of cardboard material. This manufacturing process produces inconsistent starch-based glue application, varying weight of Kraft paper GSM (grams per square meter) between production runs, and inconsistent perforation in the cardboard material when using the laser engraving or cutting methods as the intensity of the laser light changes between the top and bottom sections of the cardboard material due to the reflective mirrors moving out of maximum power range.

An objective of the present invention, a flexible inline pilaster wick, is to provide a solution to the problems described above. Specifically, the present invention offers many improvements and advantages including, but not limited to, consistent flame performance, flame heat control which allows the energy output to be dialed hotter or cooler depending on the desired outcome, consistent manufacturing methods and wick materials, the ability to provide a shapeable and crackling wooden wick system when aflame, and the ability to hold shape with ease when bent or creased. The present invention includes pilasters distributed on at least one side of a flexible wick body. The spacing between the pilasters can be adjusted to achieve desired flame height and overall heat output. Additionally, the present invention can be molded and/or formed into various shapes as the user/manufacturer desires and can be built into a free-standing candle with or without a container; furthermore, the present invention can be made of a wide variety of natural materials and efficiently built into a multiple-layer structure through sewing, gluing with various adhesives for decorative purposes.

### BRIEF SUMMARY OF THE INVENTION

According to at least one embodiment of the present invention, a candle wick is provided comprising at least a first layer of pilasters and a second layer of soft body wick material, a first layer of pilasters adhered or otherwise attached to the wick body, the pilasters parallel, spaced apart, and attached or adhered orthogonally to the longitudinal axis of the wick body. In one embodiment, the candle wick further includes a third pilaster layer opposing the first pilaster layer on the side of the wick body layer opposite the first layer of pilasters wherein the individual pilasters are spaced apart in an aligned pattern.

In one embodiment, the method of attachment of the layers together is bonding and the bonding material is one or a combination of spray adhesive, non-toxic glue, and pup bond material. In one embodiment, the wick is molded with wax and used with or without a candle container. In one embodiment, the wick is a single layer wick having only one wick body. In another embodiment, the wick is molded and stacked forming a multiple layered candle wick with multiple wick bodies. In one embodiment, the candle wick further includes a retainer clip to aid in positioning.

In a preferred embodiment, the spacing between the pilasters in a pilaster layer is set during manufacture of the wick to be as small as one and one hundred twenty-eighth of an inch to as large as 12 inches between the pilasters. In all embodiments, the wick is flexible to form radii, corners, circles, ovals, ellipses, rectangles, squares, and multifarious shapes. In one embodiment, the fuel for the wick is wax, and the wax has a same outer shape as the wick assembly. In another embodiment, the fuel for the wick is one of butane gas, propane gas, or scented oil.

In one embodiment, the wick is formed in a spiral and clipped within a container using a retainer clip. In one embodiment, the pilasters may be length adjusted to extend past the edge or edges of the wick body a desired amount. In one embodiment, the pilasters are rectangular and may include pilasters of varying widths and depths. In one embodiment, the pilaster spacing along the side of the wick body may be varied greatly wherein closer spacing produces a brighter flame at a higher flame height and more sparse spacing produces a less bright flame at a lower height.

In one embodiment, the plasters and/or the wick body are manufactured from one or a combination of cotton paper, cotton muslin, cotton thread, silk thread, silk gauze, wool, wood, cellulose, organic batting, organic woven material, or organic glue. In one embodiment, the pilasters and/or the wick body are manufactured from one or a combination of organic nut species and/or one or a combination of organic fruit species.

### BRIEF DESCRIPTION OF THE SEVERAL VIEWS OF THE DRAWINGS

FIG. 1 is a perspective view of a flexible inline pilaster type column candle wick of the preferred embodiment of the present invention.

FIG. 2 is a front view of a flexible inline pilaster type column candle wick of the preferred embodiment of the present invention.

FIG. 3 is a top view of a flexible inline pilaster type column candle wick of the preferred embodiment of the present invention.

FIG. 4 is a perspective view of a flexible inline pilaster type column candle wick and sustain/clip of the present invention.

FIG. 5 is a perspective view of a straight flexible inline pilaster type column candle wick assembly formed in wax/fuel with detachable portions of the present invention.

FIG. 6 is a top view of a straight flexible inline pilaster type column candle wick assembly formed in wax/fuel with detachable portions of the present invention.

FIG. 7 is an exploded view of a straight flexible inline pilaster type column candle wick assembly formed in wax/fuel with portions detached of the present invention.

FIG. 8 is a top view of a straight flexible inline pilaster type column candle wick formed in wax/fuel with portions detached of the present invention.

FIG. 9 is a perspective view of the multiple straight segments arrayed in close proximity to one another of the flexible inline pilaster type column candle wick formed in wax/fuel with some portions detached according to one embodiment of the present invention.

FIG. 10 is a top view of the multiple straight segments arrayed in close proximity to one another of the flexible inline pilaster type column candle wick formed in wax/fuel with some portions detached according to one embodiment of the present invention.

FIG. 11 is a perspective view of the multiple straight segments arrayed in close proximity to one another of the flexible inline pilaster type column candle wick formed in wax/fuel with some portions detached according to one embodiment of the present invention.

FIG. 12 is a top view of the multiple straight segments arrayed in close proximity to one another of the flexible inline pilaster type column candle wick formed in wax/fuel with some portions detached according to one embodiment of the present invention.

FIG. 13 is a perspective view of a curved flexible inline pilaster type column candle wick formed in wax/fuel according to one embodiment of the present invention.

FIG. 14 is a top view of a curved flexible inline pilaster type column candle wick formed in wax/fuel according to one embodiment of the present invention.

FIG. 15 is a front view of a curved flexible inline pilaster type column candle wick formed in wax/fuel according to one embodiment of the present invention.

FIG. 16 is a perspective view of a curved flexible inline pilaster type column candle wick formed in wax/fuel depicted outside of a container according to one embodiment of the present invention.

FIG. 17 is a perspective view of a curved flexible inline pilaster type column candle wick formed in wax/fuel depicted inside of a container according to one embodiment of the present invention.

FIG. 18 is a perspective view of one design variation of multiple curved segments arrayed in close proximity to one another of the flexible inline pilaster type column candle wick formed in wax/fuel according to one embodiment of the present invention.

FIG. 19 is a top view of one design variation of multiple curved segments arrayed in close proximity to one another of the flexible inline pilaster type column candle wick formed in wax/fuel according to one embodiment of the present invention.

FIG. 20 is a perspective view of one design variation of multiple curved segments arrayed in close proximity to one another of the flexible inline pilaster type column candle wick formed in wax/fuel according to one embodiment of the present invention.

FIG. 21 is a top view of one design variation of multiple curved segments arrayed in close proximity to one another of the flexible inline pilaster type column candle wick formed in wax/fuel according to one embodiment of the present invention.

FIG. 22 is a perspective view of one design variation of multiple curved segments arrayed in close proximity to one another of the flexible inline pilaster type column candle wick formed in wax/fuel according to one embodiment of the present invention.

FIG. 23 is a top view of one design variation of multiple curved segments arrayed in close proximity to one another of the flexible inline pilaster type column candle wick formed in wax/fuel according to one embodiment of the present invention.

FIG. 24 is a perspective view of one design variation of an array of multiple radii flexible inline pilaster type column candle wicks formed in wax/fuel depicted outside of a container according to one embodiment of the present invention.

FIG. 25 is a top view of one design variation of an array of multiple radii flexible inline pilaster type column candle wicks formed in wax/fuel depicted inside of a container according to one embodiment of the present invention.

FIG. 26 is a perspective view of one design variation of a multifariously shaped flexible inline pilaster type column candle wick formed in wax/fuel depicted outside of a container according to one embodiment of the present invention.

FIG. 27 is a perspective view of one design variation of a multifariously shaped flexible inline pilaster type column candle wick formed in wax/fuel depicted inside of a container according to one embodiment of the present invention.

FIG. 28 is a top view of one design variation of a multifariously shaped flexible inline pilaster type column candle wick formed in wax/fuel depicted inside of a container according to one embodiment of the present invention.

FIG. 29 is a perspective view of multiple design variations of the flexible inline pilaster type column candle wick formed in wax/fuel depicted outside of a container according to one embodiment of the present invention.

FIG. 30 is a top view of multiple design variations of the flexible inline pilaster type column candle wick formed in wax/fuel depicted inside of a container according to one embodiment of the present invention.

FIG. 31 is a perspective view of a mold to form the flexible inline pilaster type column candle wick pilasters, the three layers of the flexible inline pilaster type column candle wick separated, and the flexible inline pilaster type column candle wick layers joined together according to one embodiment of the present invention.

FIG. 32 is a top view of a mold to form the flexible inline pilaster type column candle wick pilasters, the three layers of the flexible inline pilaster type column candle wick separated, and the flexible inline pilaster type column candle wick layers joined together according to one embodiment of the present invention.

FIG. 33 is a perspective view of one design variation of a three-dimensional mold fitted in its entirety with the flexible inline pilaster type column candle wick; set aflame, according to one embodiment of the present invention.

FIG. 34 is a front view of one design variation of a three-dimensional mold fitted in its entirety with the flexible inline pilaster type column candle wick; set aflame, according to one embodiment of the present invention.

FIG. 35 is a top view of one design variation of a three-dimensional mold fitted in its entirety with the flexible inline pilaster type column candle wick, according to one embodiment of the present invention.

FIG. 36 is a perspective view of one design variation of an extrusion mold/die press system used to form the flexible inline pilaster type column candle wick, according to one embodiment of the present invention.

FIG. 37 is a front view of one design variation of an extrusion mold/die press system used to form the flexible inline pilaster type column candle wick, according to one embodiment of the present invention.

FIG. 38 is a perspective view of one design variation of an extrusion mold/die press system used to form the flexible inline pilaster type column candle wick; mixed components are shown being forced through the system, according to one embodiment of the present invention.

FIG. 39 is a front view of one design variation of an extrusion mold/die press system used to form the flexible inline pilaster type column candle wick; mixed components are shown being forced through the extrusion chamber, according to one embodiment of the present invention.

FIG. 40 is a perspective view of one design variation of an extruded multifariously shaped mold of the flexible inline pilaster type column candle wick, according to one embodiment of the present invention.

FIG. 41 is a perspective view of one design variation of multiple stacked layers of an extruded multifariously shaped mold of the flexible inline pilaster type column candle wick, according to one embodiment of the present invention.

FIG. 42 is a top view of one design variation of an extruded multifariously shaped mold of the flexible inline pilaster type column candle wick, according to one embodiment of the present invention.

FIG. 43 is a perspective view of a spiral design of the flexible inline pilaster type column candle wick depicted in a twisted position, according to one embodiment of the present invention.

FIG. 44 is a front view of a spiral design of the flexible inline pilaster type column candle wick depicted in a twisted position, according to one embodiment of the present invention.

FIG. 45 is a front view of a spiral design of the flexible inline pilaster type column candle wick depicted in an open, a flat, or otherwise untwisted position, according to one embodiment of the present invention.

FIG. 46 is a perspective view of a spiral design of the flexible inline pilaster type column candle wick depicted in either an open/flat/untwisted or twisted position surrounded by wax/fuel, outside of container, according to one embodiment of the present invention.

FIG. 47 is a perspective view of a spiral design of the flexible inline pilaster type column candle wick depicted in either an open/flat/untwisted or twisted position, surrounded by wax/fuel, inside of container, according to an embodiment of the present disclosure.

### DETAILED DESCRIPTION OF THE INVENTION

In various embodiments described in enabling detail herein, the inventor provides a unique flexible inline pilaster wick apparatus. All illustrations of the drawings are for the purpose of describing selected versions of the present invention and are not intended to limit the scope of the present invention. The present invention is described using the following examples which may describe more than one relevant embodiment falling within the scope of the invention.

The present invention provides a flexible candle wick assembly that comprises protruding pilasters oriented in parallel and distributed across an elongated wick body. The flexible candle wick is pliable and allows a user to shape it into simple or complex structures. The present invention includes one or more layers and can absorb fuel with efficient capillary action to deliver wax/fuel to a flame. When ignited, the candle wick provides a substantially consistent burning throughout the body of the candle so that the flame remains kindled and does not distinguish because of the continuous supply of fuel through the wick. The spacing between the parallel pilasters can be adjusted to control the height of the flame and the overall heat output.

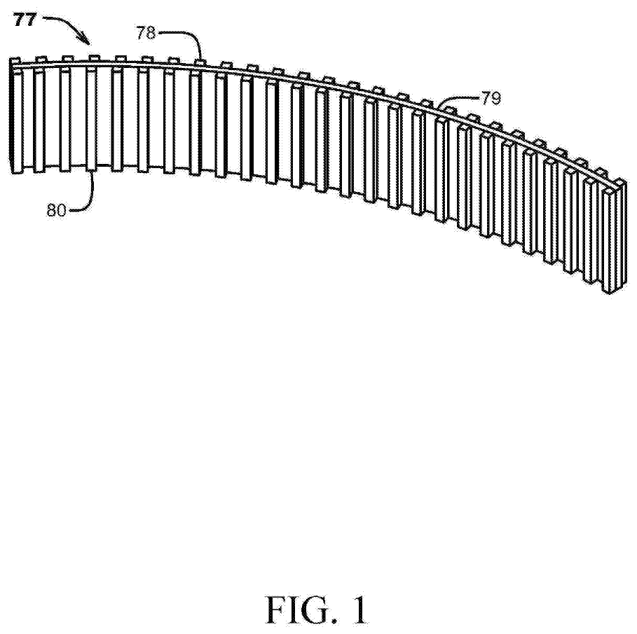

As seen in FIGS. 1-3, the preferred embodiment of the present invention comprises a first layer, a second layer, and a third layer. The second layer includes a flexible wick body. The first layer comprises a plurality of pilasters which are terminally positioned on and distributed across the second layer wick body. The plurality of pilasters is oriented perpendicular to the longitudinal axis of the second layer wick body and transverses along the lateral surface of the second layer wick body. The third layer comprises a plurality of pilasters which are terminally positioned on and distributed across the second layer wick body, opposite the first layer along the second layer wick body. The spacing between the plurality of pilasters of the first layer is equal to the spacing between the plurality of pilasters of the second layer. Additionally, the spacing between the plurality of pilasters of both the first and second layers can be adjusted such that the user can efficiently control the height of the flame and the overall heat output of the candle. Other embodiments of the present invention may include only one layer of the plurality of pilasters distributed across one side of the second layer wick body.

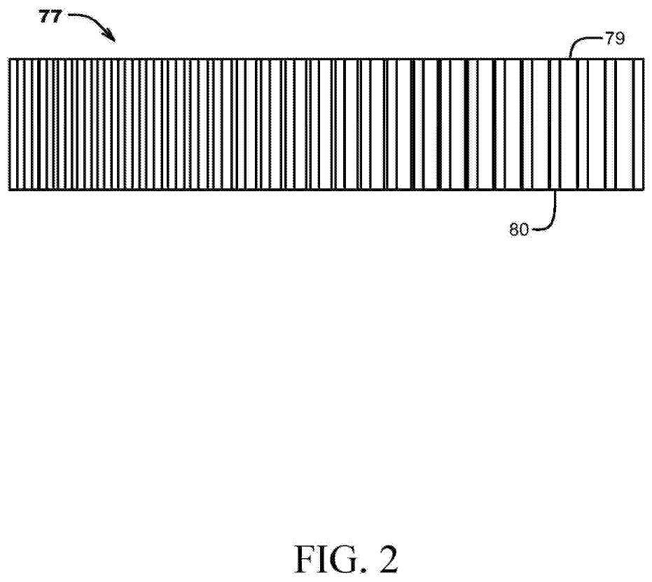

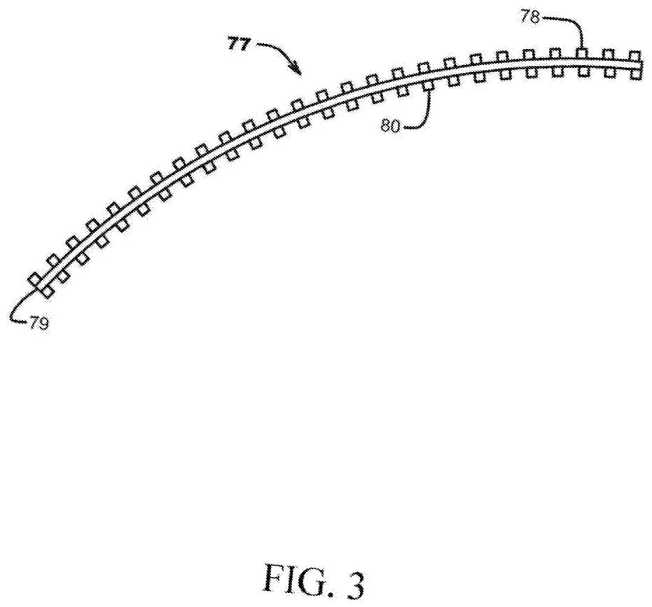

FIG. 1 is an isometric perspective view of a flexible inline pilaster type column pilaster wick assembly of the preferred embodiment of the present invention. FIG. 2 is a front view of a flexible inline pilaster type column candle wick assembly of the preferred embodiment of the present invention. FIG. 3 is a top view of a flexible inline pilaster type column candle wick assembly of the preferred embodiment of the present invention.

Referring to FIGS. 1-3, in a preferred embodiment of the present invention, a flexible inline pilaster wick assembly 77 is provided and includes a first pilaster layer 78, a second flexible wick material body 79, and a third pilaster layer 80. The first layer 78 comprises a plurality of pilasters which are terminally positioned on and distributed across second layer wick body 79. The plurality of pilasters in layer 78 is oriented perpendicularly to the longitudinal axis of wick body 79 and transverse along the lateral surface of the wick body 79. The third layer 80 comprises a plurality of pilasters which are terminally positioned on and distributed across the second layer wick body 79, opposite the first layer 78 deposited along the wick body 79. In this embodiment, the spacing between the plurality of pilasters in the first layer 78 is equal to the spacing between the plurality of pilasters in the third layer 80.

In one embodiment, the pilaster spacing dimensions between the plurality of pilasters of both the first layer 78 and the third layer 80 can be adjusted so that a user may efficiently control the height of a flame and the overall heat output of a candle. In one embodiment of the present invention, there may be only a single layer of pilasters distributed across one side of the second layer wick body 79.

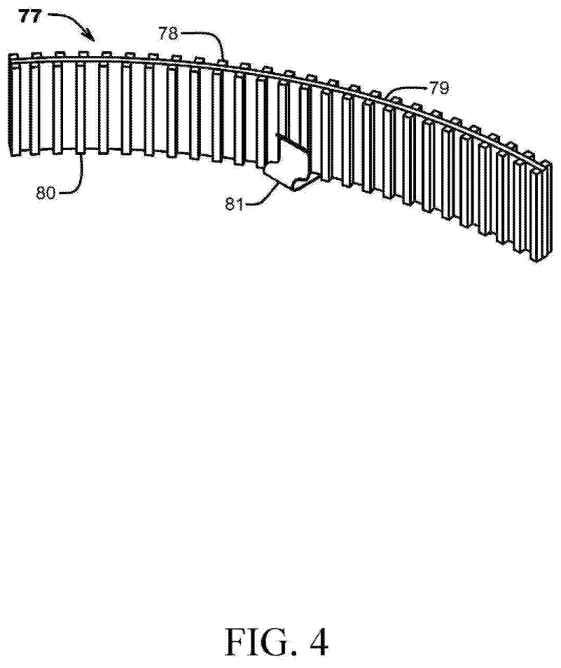

FIG. 4 is an isometric perspective view of a flexible inline pilaster type column candle wick and sustain/clip of the present invention. Referring to FIG. 4, the pilaster wick assembly 77 further includes a retainer clip 81. Retainer clip 81 may be terminally or detachably mounted to the wick body 79 and/or to the outside edges of layers 78 and 80. Retainer clip 81 provides support whenever the wick assembly 77 is used in a candle container.

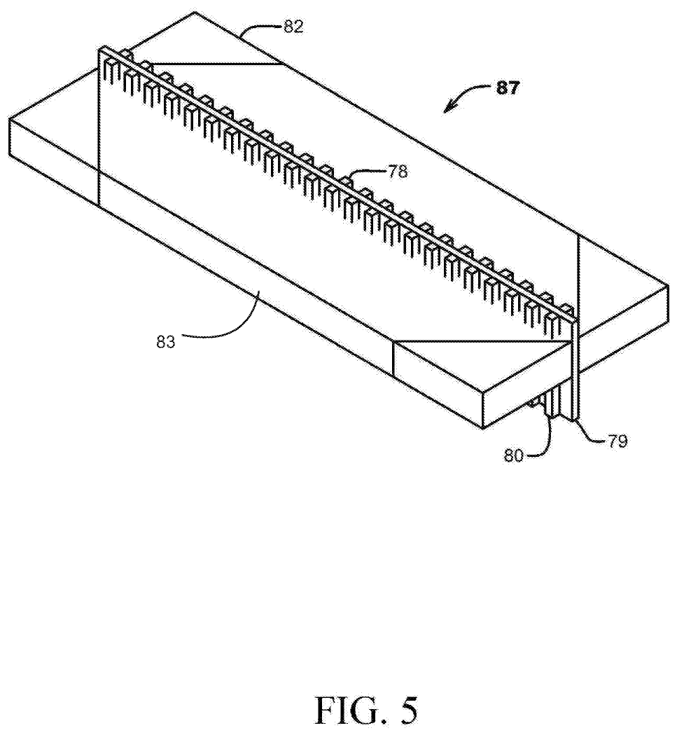

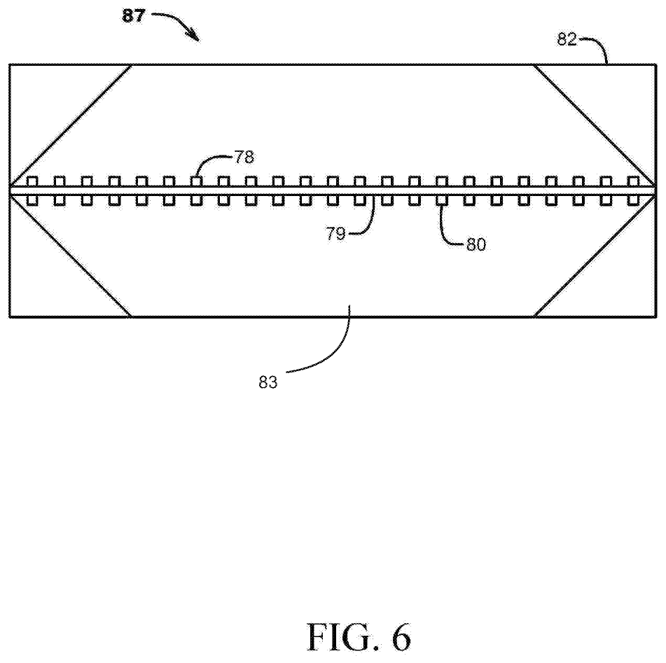

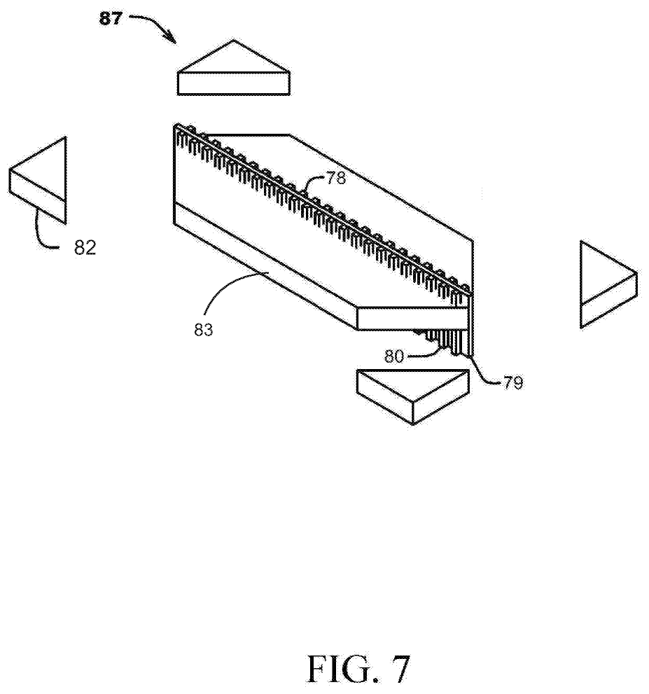

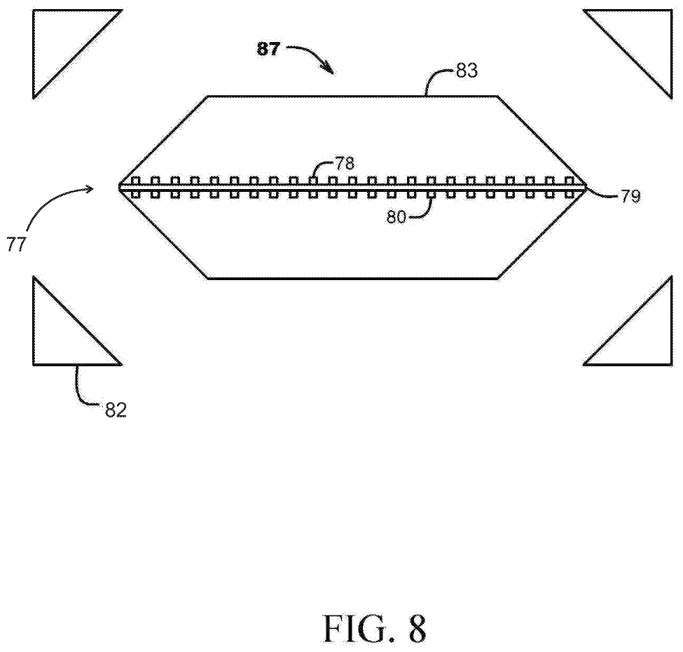

FIG. 5 is a perspective view of a straight flexible inline pilaster type column candle wick assembly 87 formed in wax/fuel with detachable portions of the present invention. FIG. 6 is a top view of flexible inline pilaster type column candle wick assembly 87 formed straight in wax/fuel with detachable portions. FIG. 7 is an exploded view of the straight flexible inline pilaster type column candle wick assembly 87 formed in wax/fuel with portions detached of the present invention. FIG. 8 is a top view of a straight flexible inline pilaster type column candle wick assembly 87 of FIG. 7 formed in wax/fuel with portions thereof detached or removed.

Referring to FIGS. 5-8, in one embodiment flexible pilaster wick is a candle assembly assembly in a linear configuration and includes the flexible pilaster wick assembly 77 surrounded by wax/fuel 83. Also shown are detachable corners 82, wick body 79, and pilaster wick layers 78 and 80. In this embodiment there is no candle container. The shape of the linear configuration may include but not limited to, rectangular, square, circular, cylindrical, oval, or the like.

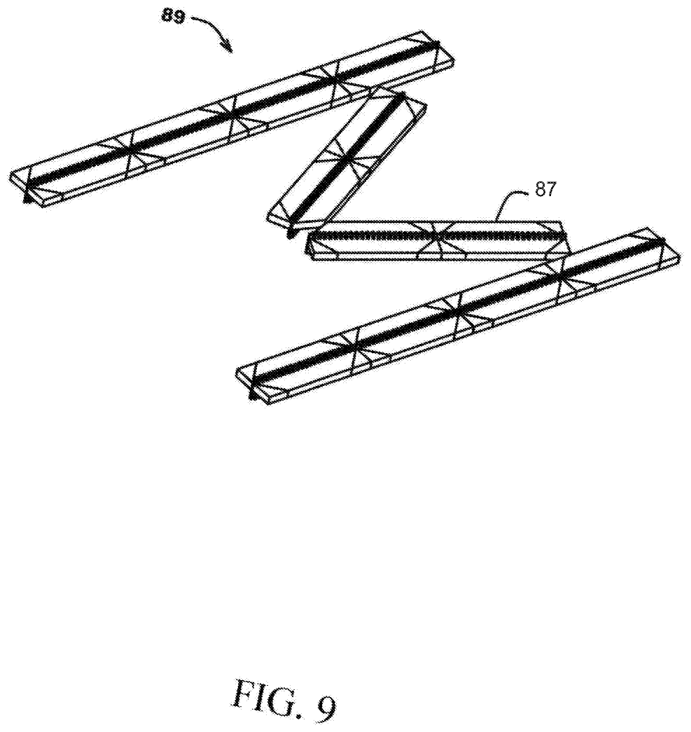

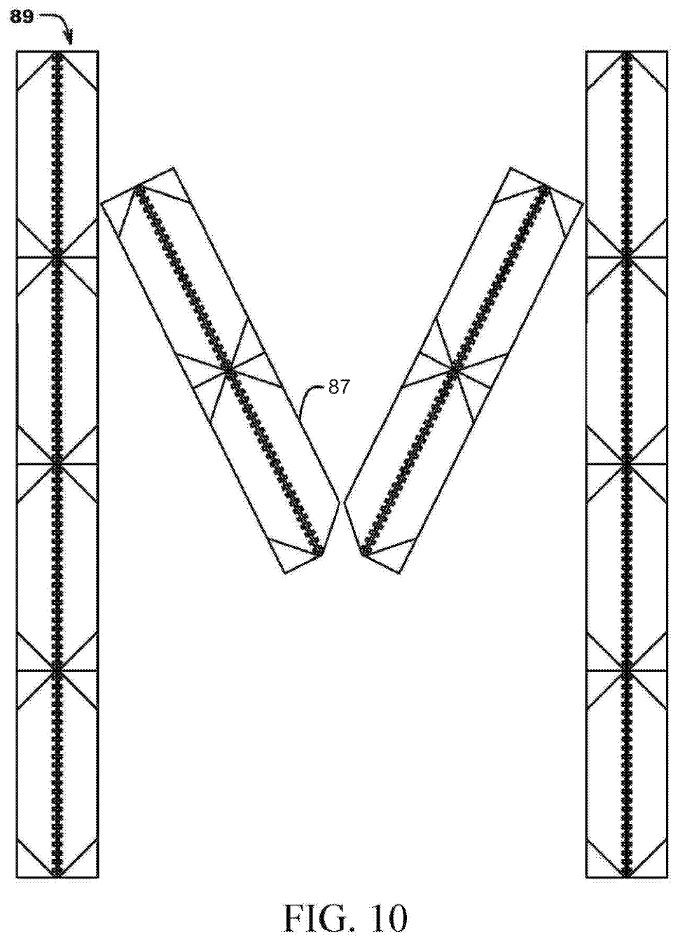

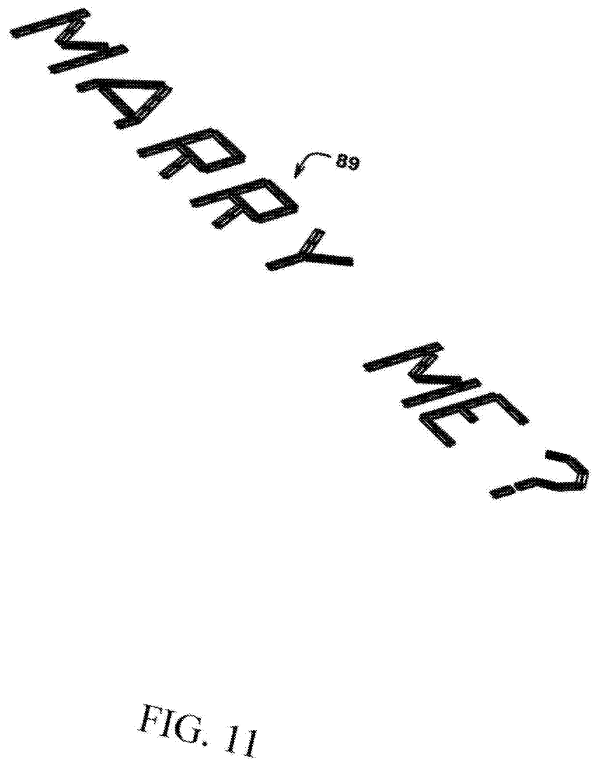

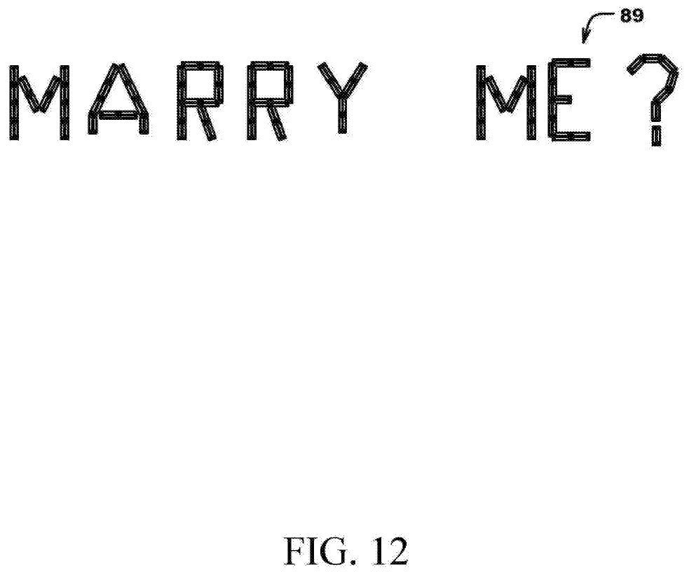

FIG. 9 is a perspective view of multiple straight segment configuration 89 of pilaster candle wick 87 arrayed in close proximity to one another of the flexible inline pilaster type column candle wick formed in wax/fuel with some portions removed according to one embodiment of the present invention. FIG. 10 is a top view of a wick configuration 89 formed from multiple straight segments of candle wick 87 are arrayed in close proximity to one another. In this view some material has been removed for clarity. FIG. 11 is a perspective view of the multiple straight segment configuration 89 arrayed in close proximity to one another of the flexible inline pilaster type column candle wick formed in wax/fuel with some portions detached according to one embodiment of the present invention. FIG. 12 is a top view of the multiple straight segment configuration 89 arrayed in close proximity to one another of the flexible inline pilaster type column candle wick formed in wax/fuel with some portions detached according to one embodiment of the present invention.

Referring to FIGS. 9-12, in one embodiment of the present invention a wick configuration 89 may be created by a user having cut pilaster wick assembly 87 into a plurality of straight sections and forming a letter. There is no candle container in this embodiment. The shape of each of the plurality of the linear configurations may include, but not limited to, rectangular, square, circular, cylindrical, oval, or the like. The plurality of linear wick sections of the present invention can be arranged and or structured into letters, sentences, or any decorative shapes without departing from the spirit and scope of the present invention. The overall shape of configuration 89 can be any form the user desires.

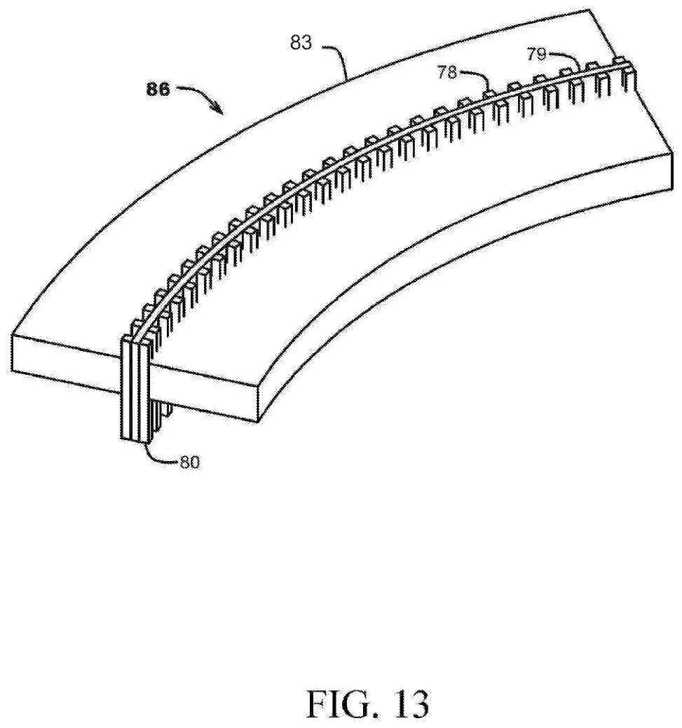

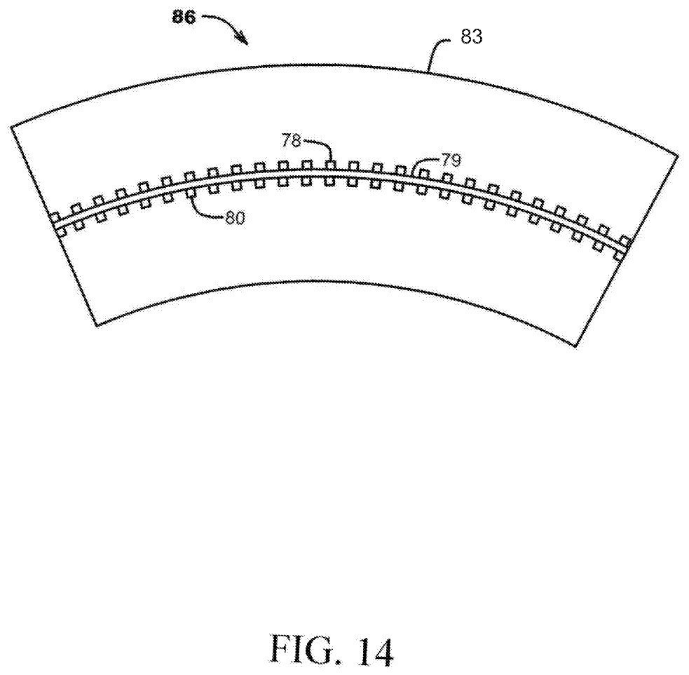

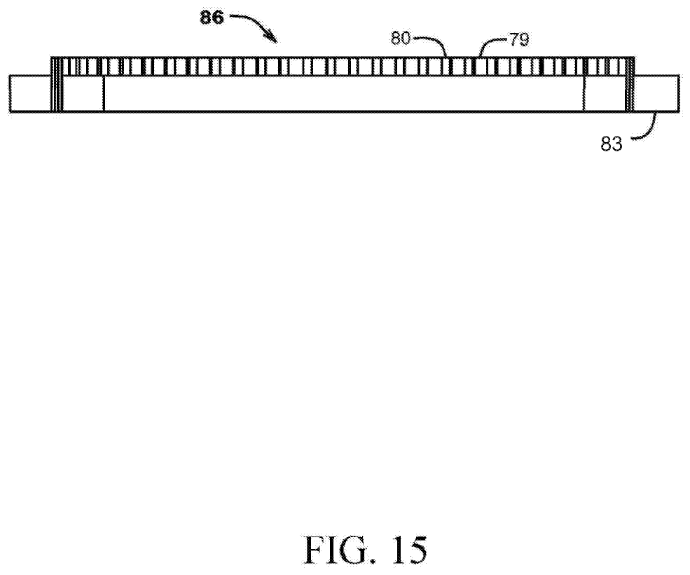

FIG. 13 is a perspective view of a curved flexible inline pilaster type column candle wick 86 formed with wax/fuel 83 showing wick body 79 with pilaster layers 78 and 80 embedded according to one embodiment of the present invention. FIG. 14 is a top view of a curved flexible inline pilaster type column candle wick 86 formed with wax/fuel 83 showing wick body 79 with pilaster layers 78 and 80 embedded according to one embodiment of the present invention. FIG. 15 is a front view of a curved flexible inline pilaster type column candle wick 86 formed in wax/fuel 83 showing wick body 79 with pilaster layers 78 and 80 embedded according to one embodiment of the present invention.

Referring to FIGS. 13-15, in one embodiment of the present invention, the flexible pilaster wick assembly formed or molded into a curved configuration 86. The configuration includes wick 87 including first layer 78, wick body 79, and third layer 80. Wax/fuel 83 is curved along the same radii and configuration 86 does not include a candle container. The shape of the linear configuration 86 may include but not limited to, partially circular, partially oval, or the like.

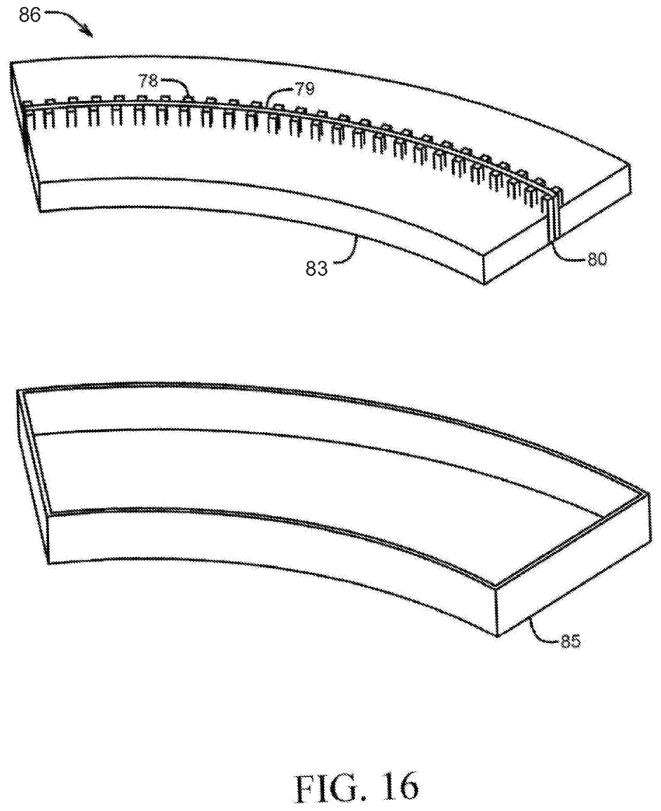

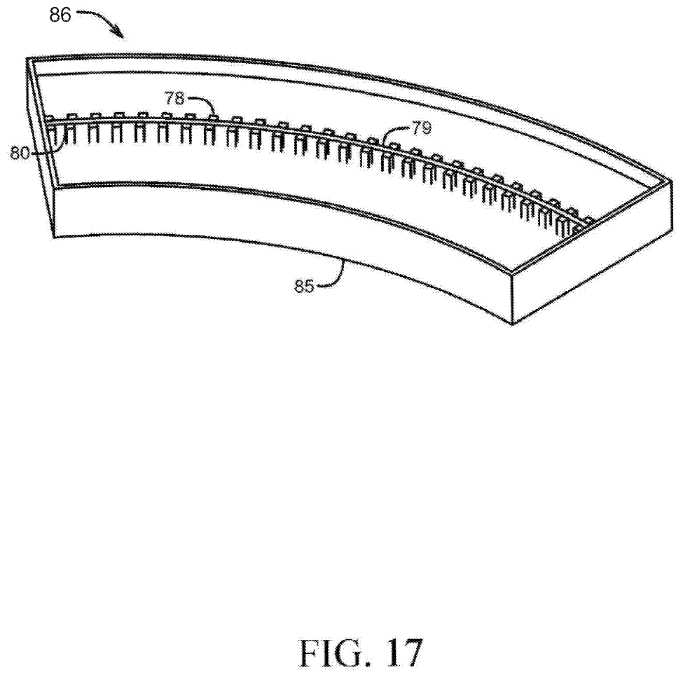

FIG. 16 is a perspective view of a curved flexible inline pilaster type column candle wick formed in wax/fuel depicted outside of a container according to one embodiment of the present invention. FIG. 17 is a perspective view of the curved flexible inline pilaster type column candle wick formed in wax/fuel of FIG. 16 depicted inside of a container according to one embodiment of the present invention.

Referring now to FIGS. 16-17 in one embodiment, a flexible pilaster wick configuration 86 depicted in curved configuration which includes the wax/fuel 83 showing wick body 79 with pilaster layers 78 and 80 embedded beside a candle container 85. The shape of the container 85 and the curved configuration 86 includes, but not limited to, partially circular, partially oval, etc. FIG. 17 shows curved candle 86 resting inside container 85.

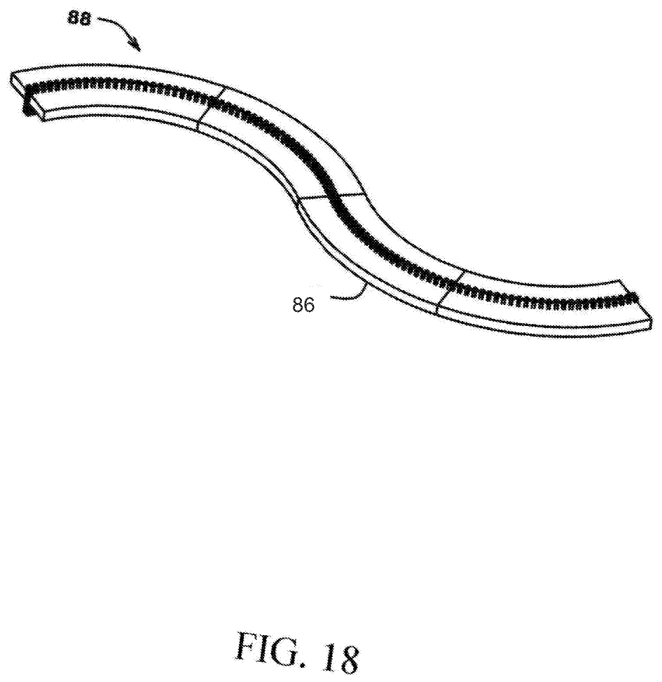

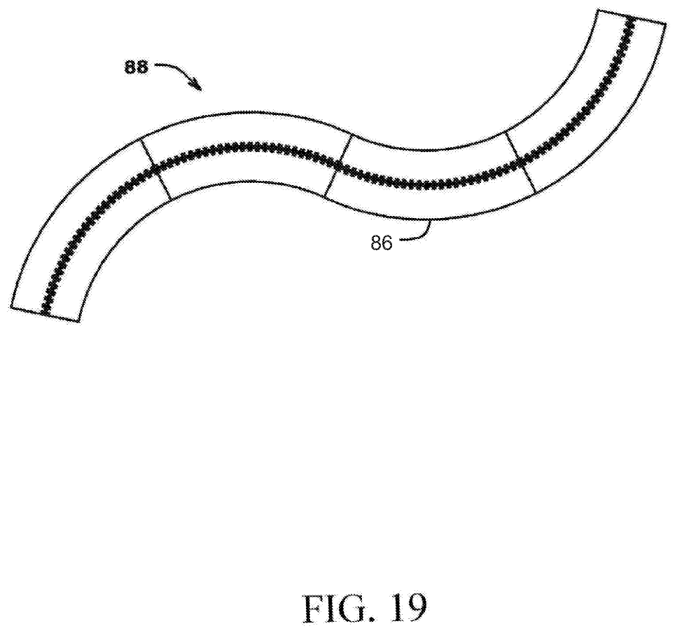

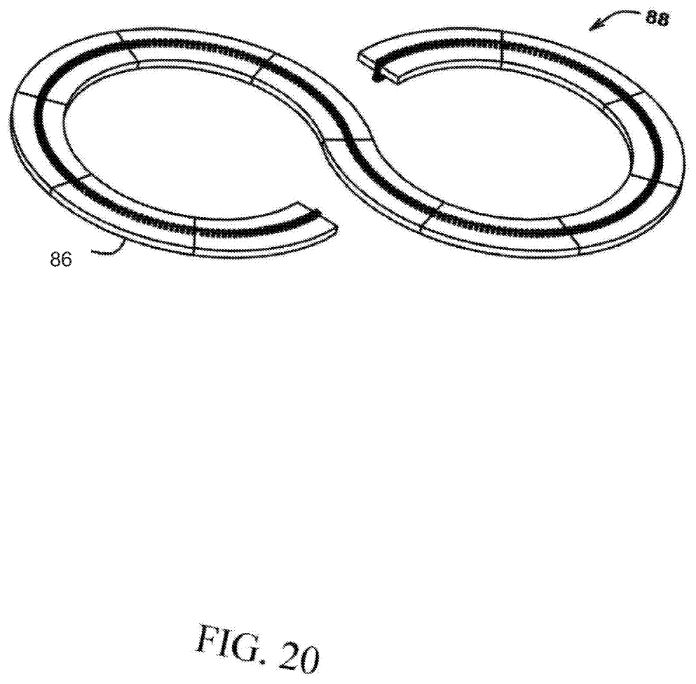

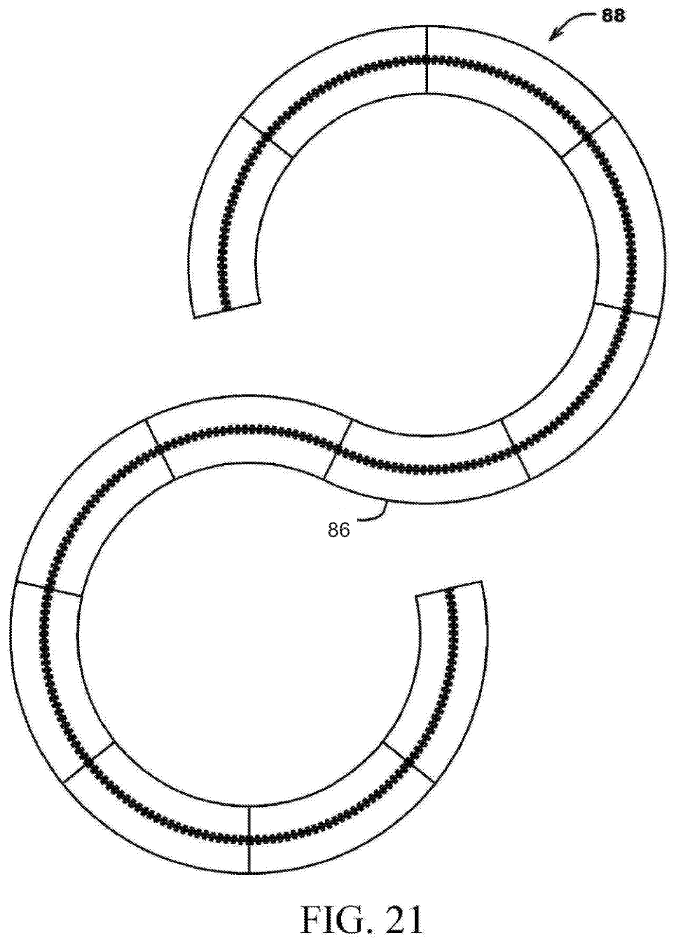

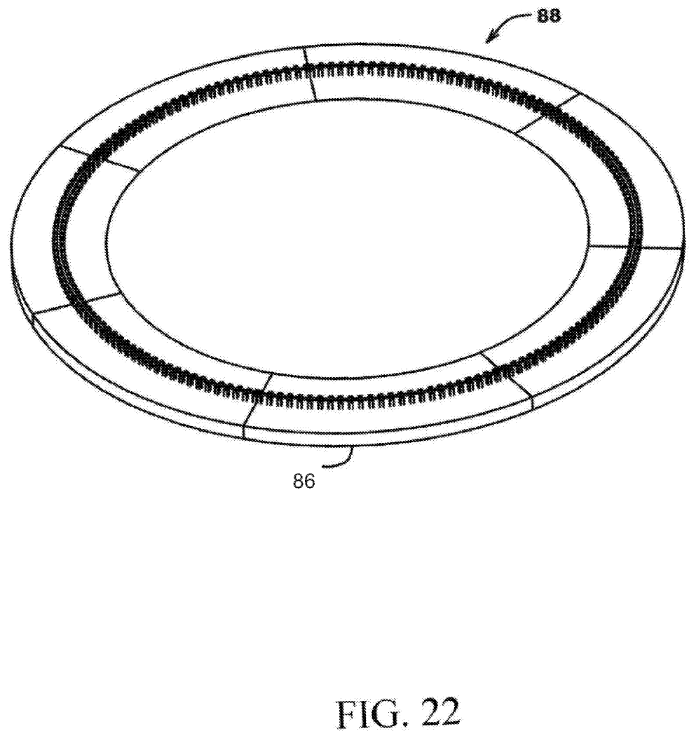

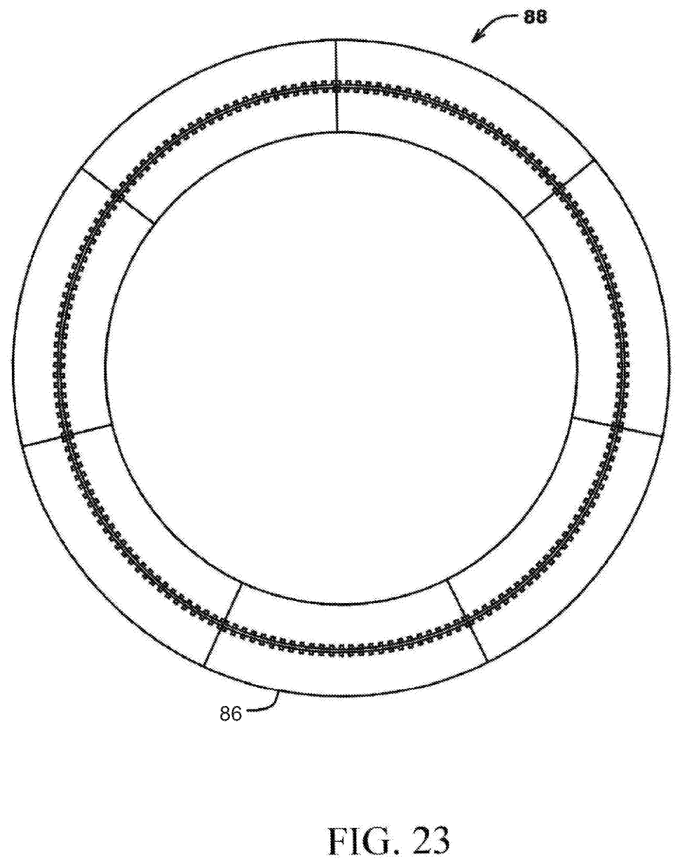

FIG. 18 is a perspective view of one design variation or configuration 88 of multiple curved segments analogous to curved candle segments 86 of FIG. 13 arrayed in close proximity to one another. FIG. 19 is a top view of configuration 88 comprising multiple curved segments 86 arrayed in close proximity to one another according to one embodiment of the present invention. FIG. 20 is a perspective view of a configuration analogous to configuration 88 of curved candle segments 86 assembled in close proximity to one another according to one embodiment of the present invention. FIG. 21 is a top view of configuration 88 of FIG. 20. FIG. 22 is a perspective view of a configuration 88 arrayed in the form of a circle. FIG. 23 is a top view of configuration 88 of FIG. 22 arrayed in the form of a circle

Referring now to FIGS. 18-23, curved candle segments 86 having a like radius may be formed in curvy linear forms for decorative purpose. In this embodiment, curved candle 86 is carved or otherwise formed in the same circular shape as the pilaster wick. In this embodiment there is no container. The shape of the curved candle 86 may include but is not limited to, partially circular, partially oval, circular, oval, “S” curve, or the like.

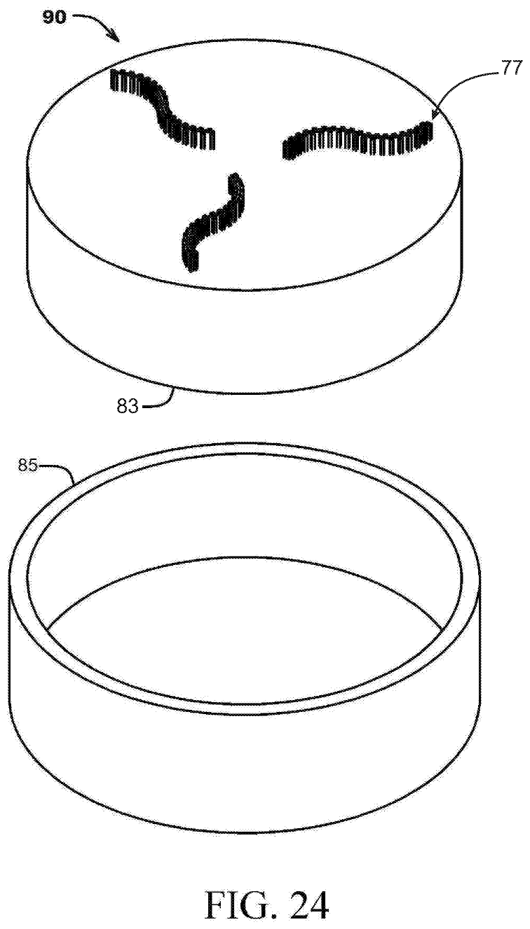

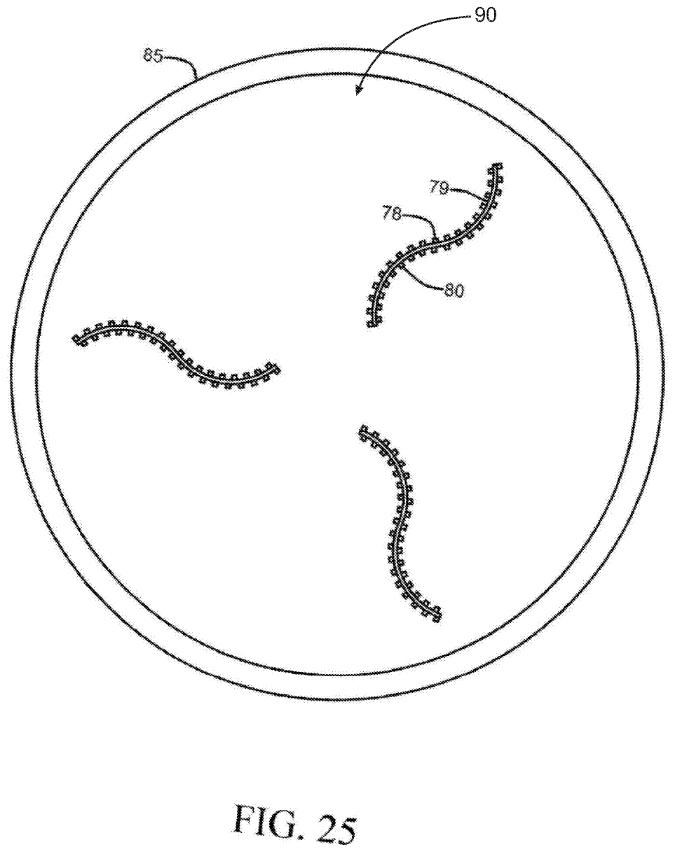

FIG. 24 is a perspective view of a configuration 90 including an array of flexible inline pilaster type column candle wicks analogous to pilaster wick 77 of FIG. 1 formed with multiple opposing radii in wax/fuel 83. The configuration is depicted beside a circular container 85 according to one embodiment of the present invention. FIG. 25 is a top view of configuration 90.

Referring now to FIGS. 24-25, configuration 90 includes three wicks analogous to wick 77 of FIG. 1 embedded in a circular plug wax/fuel 83. In this view the wicks analogous to wicks 77 are curved in a minor S form and arrayed at 120-degree radial axes in a concentric relationship with circular wax/fuel 83. FIG. 24 depicts the configuration beside a container 85 while FIG. 25 depicts configuration 90 placed within container 85 and showing wick body 79 with pilaster layers 78 and 80 embedded.

The shape of each of the plurality of flexible pilaster wicks may include but not limited to, partially circular, partially oval, circular, oval, “S” curve, etc. The plurality of flexible pilaster wicks is arranged into a specific shape including, but not limited to, a triple spoke array, or any other type of array. The shape of the containers includes, but not limited to, rectangular, square, circular, oval, or the like.

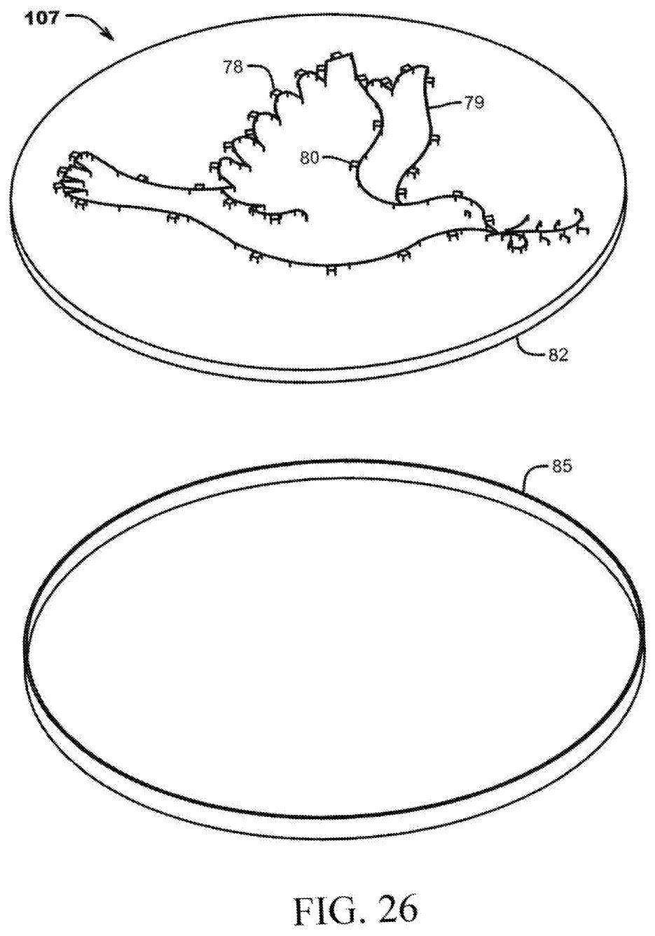

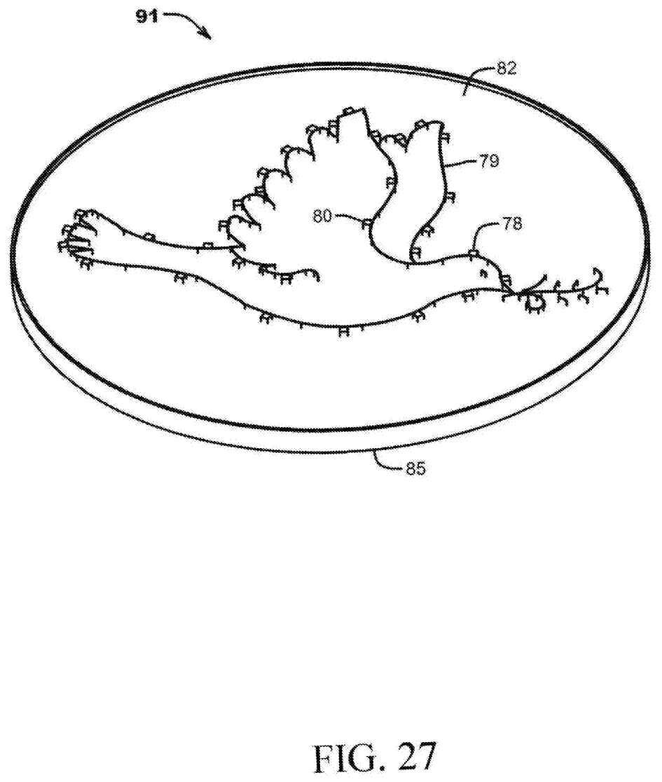

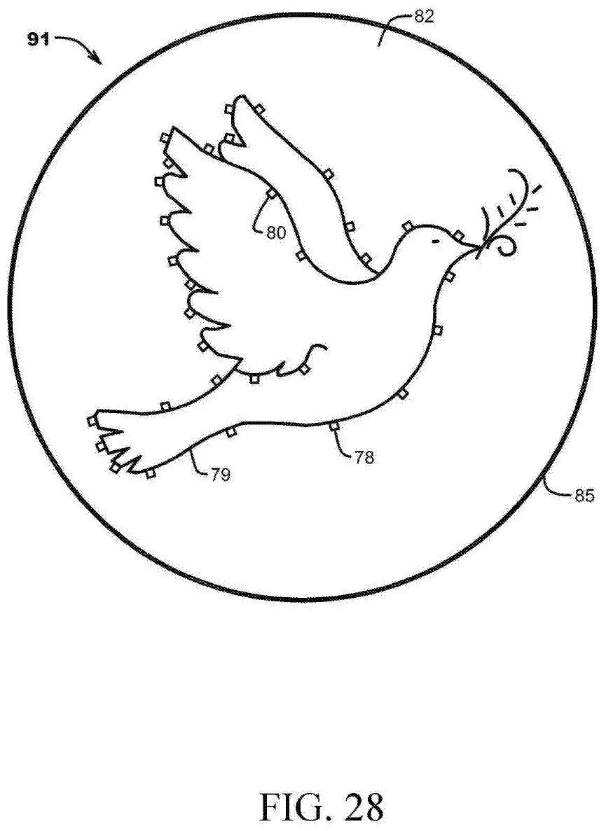

FIG. 26 is a perspective view of a configuration 107 depicting pilaster wicks analogous to wicks 77 of FIG. 1 arrayed in the form of a multifarious shape of a bird, for example, a dove. Configuration 107 includes the wicks embedded in a relatively thin but uniform circular wax/fuel 83. Configuration 107 is depicted beside a candle container 85 analogous albeit thinner in dimension to match the thickness of the plug wax/fuel 83. FIG. 27 is a perspective view of configuration 107 depicted inside of container 85. FIG. 28 is a top view of configuration 107 placed inside candle container 85.

Referring to FIGS. 26-28, the shape of each of the plurality of flexible pilaster wick assemblies includes, but not limited to a dove, or any other custom shape. Each of the plurality of flexible pilaster wicks is arranged into a specific shape for decoration per the user's preference, including, but not limited to, linear, partially circular, partially oval, circular, oval, “S” curve, etc. The shape of the containers includes, but not limited to, rectangular, square, circular, oval, etc. Each of the plurality of flexible pilaster wicks can be a single layer or a plurality of layers. Pilaster layers 78 and 80 as well as wick body 79 are depicted and comprise the lines of the multifarious shape.

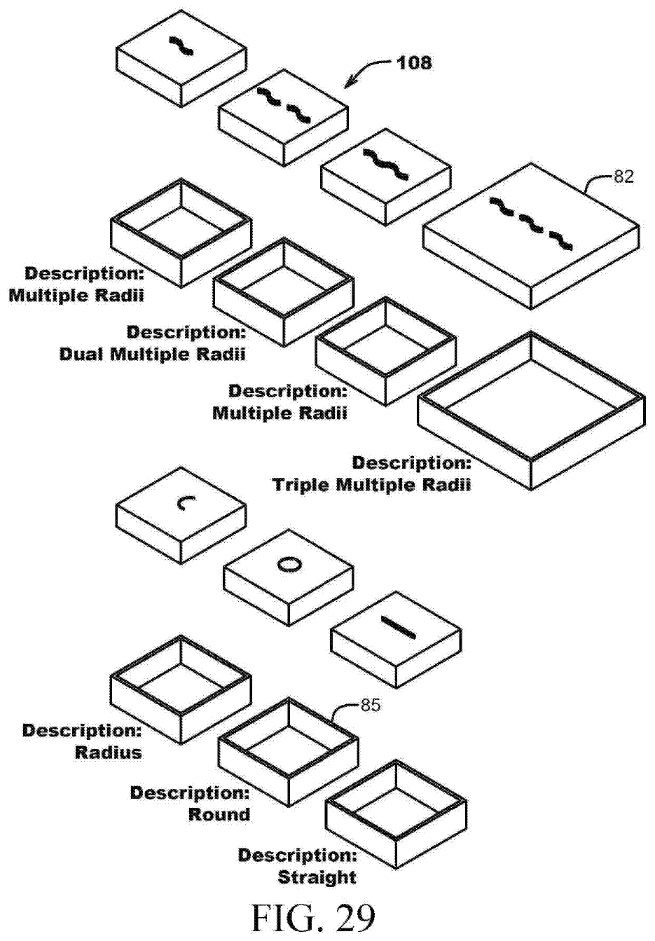

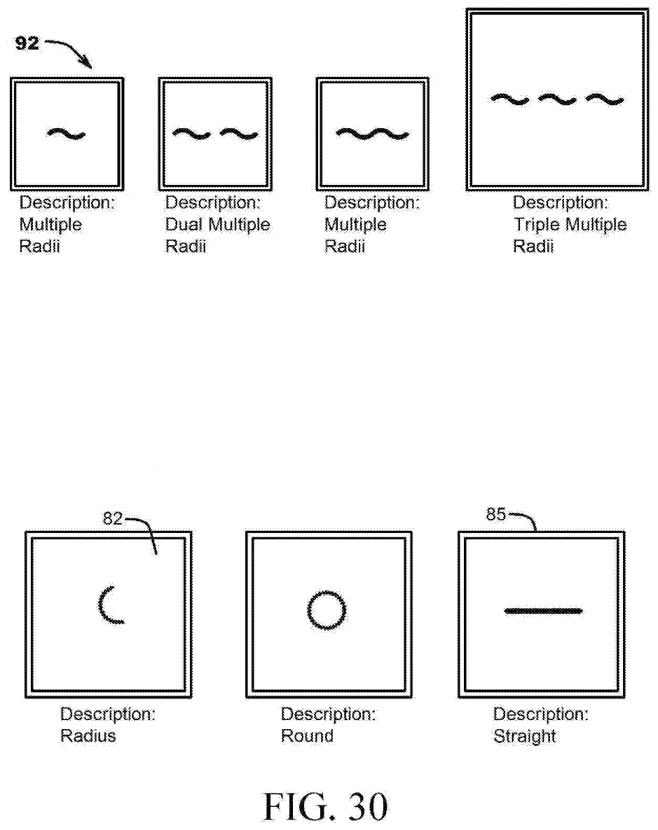

FIG. 29 is a perspective view of multiple configurations of the flexible inline pilaster type column candle wicks analogous to wick assembly 77 of FIG. 1 formed in rectangular wax/fuel 83. In this view the configurations 108 are depicted beside candle containers 85, which may be rectangular versions of candle container 85 of FIG. 24 or 26. FIG. 30 is a top view of the configurations 108 of FIG. 29 placed inside candle containers 85.

Referring now to FIGS. 29 and 30, the shape of each of the plurality of flexible pilaster wick assemblies includes, but not limited to linear, partially circular, partially oval, circular, oval, “S” curve, alphabetic letter, numeral, etc. Each of the plurality of flexible pilaster wicks is arranged into a specific shape for decoration per the user's preference, including, but not limited to, linear, partially circular, partially oval, circular, oval, “S” curve, or any other custom shape. The shape of the containers includes, but not limited to, rectangular, square, circular, oval, etc. Each of the plurality of flexible pilaster wicks can be a single layer or a plurality of layers.

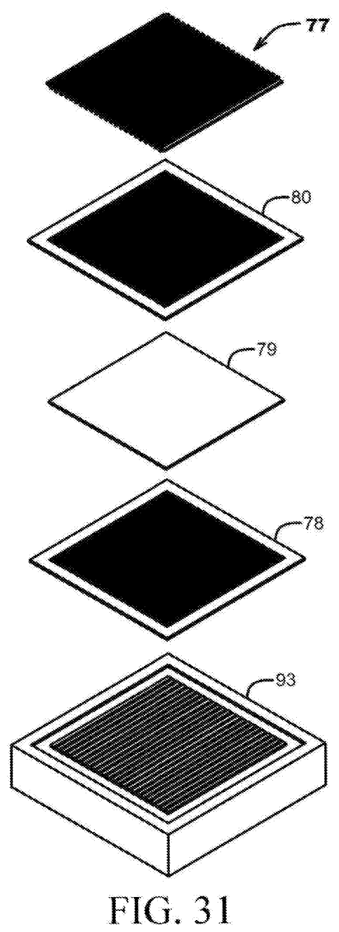

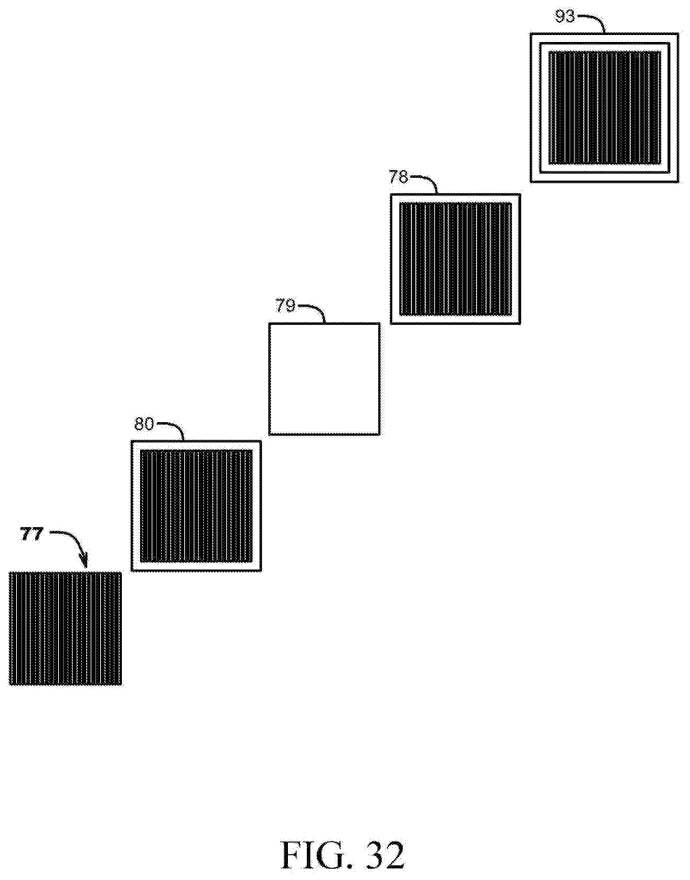

FIG. 31 is a perspective view of a mold to form the flexible inline pilaster type column candle wick pilasters, the three layers of the flexible inline pilaster type column candle wick separated, and the flexible inline pilaster type column candle wick layers joined together according to one embodiment of the present invention. FIG. 32 is a top view of the mold to form the flexible inline pilaster type column candle wick pilasters, the three layers of the flexible inline pilaster type column candle wick separated, and the flexible inline pilaster type column candle wick layers joined together according to one embodiment of the present invention.

Referring to FIGS. 31 and 32, the flexible pilaster wick assembly 77 described further above in FIG. 1 and following figures is formed in a mold and dies 93. The mold and die include the first pilaster layer 78, the second layer wick body 79, and the third pilaster layer 80 which when formed together create pilaster wick assembly 77. The mold/die 93 is used to form the pilaster wick of the invention. The shape of the present invention, the flexible pilaster wick, matches the shape of the mold/die, which includes, but not limited to rectangular, oval, or circular shape, or the like.

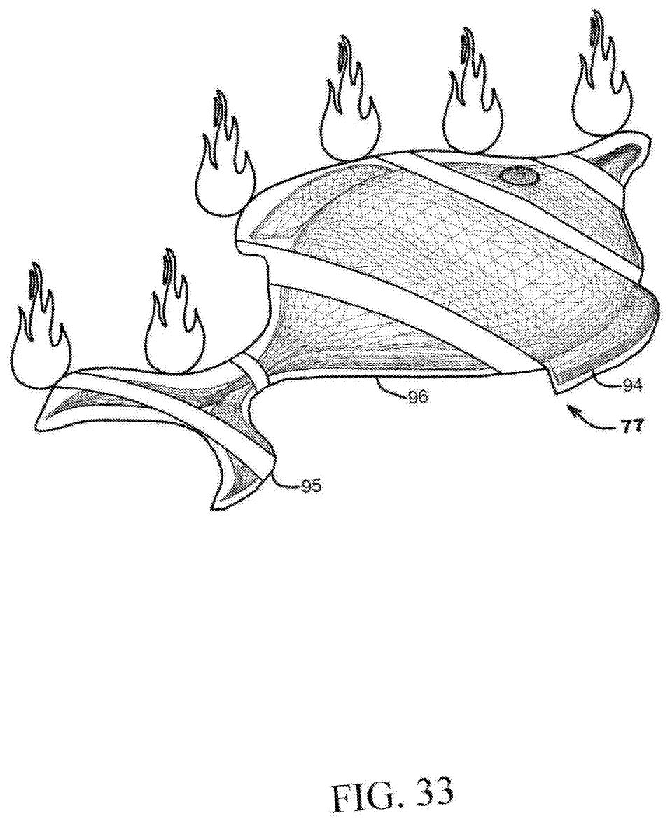

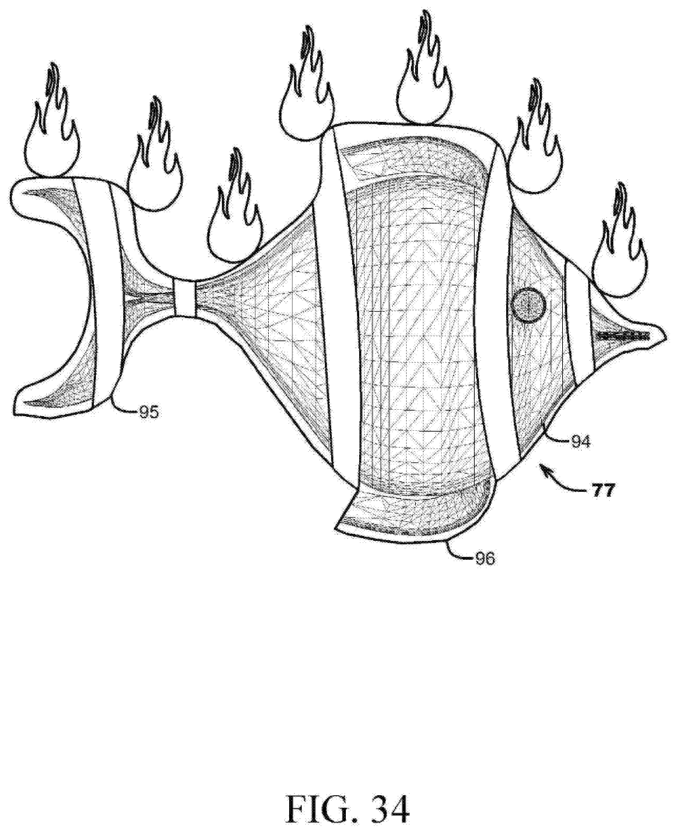

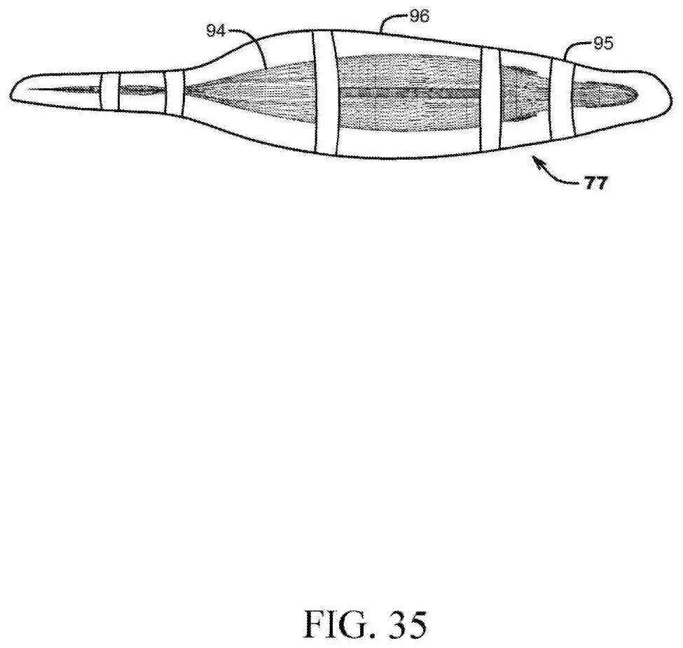

FIG. 33 is a perspective view of one design variation of a three-dimensional configuration 88 fitted in its entirety with the flexible inline pilaster type column candle wick assembly 77 set aflame, according to one embodiment of the present invention. FIG. 34 is a front view of one design variation of a three-dimensional mold fitted in its entirety with the flexible inline pilaster type column candle wick; set aflame, according to one embodiment of the present invention. FIG. 35 is a top view of one design variation of a three-dimensional mold configuration 88 fitted in its entirety with the flexible inline pilaster type column candle wick assembly 77 according to one embodiment of the present invention.

Referring to FIGS. 33-35 is a flexible pilaster wick assembly 77 in a three-dimensional mold configuration 88. The mold configuration 88 is a custom designed body/decoration. The pilaster wick assembly 77 is molded around the girth/perimeter of the mold configuration 88. The shape of the present invention, the flexible pilaster wick assembly 77, matches the shape of the mold configuration 88, which includes any custom shapes such as the shape of a fish.

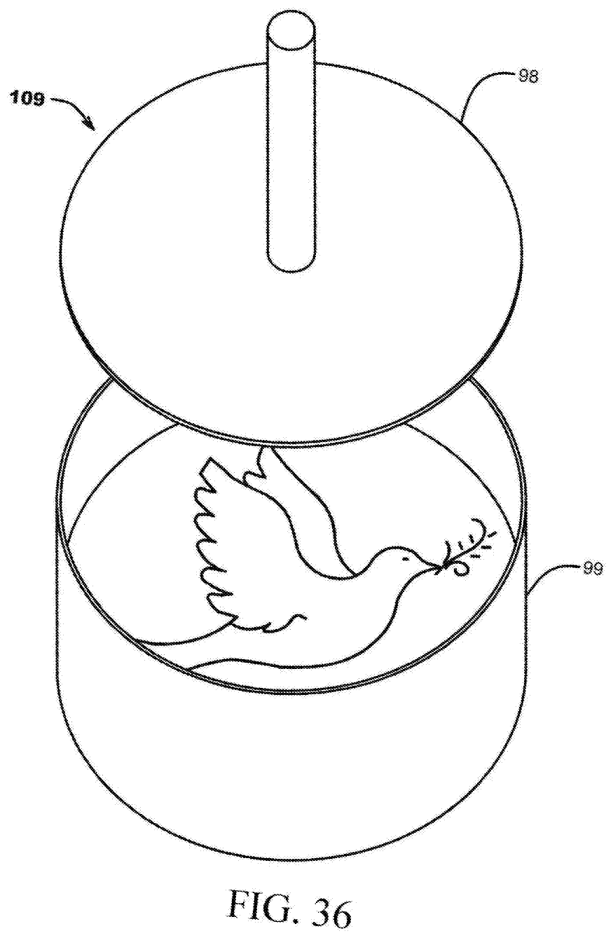

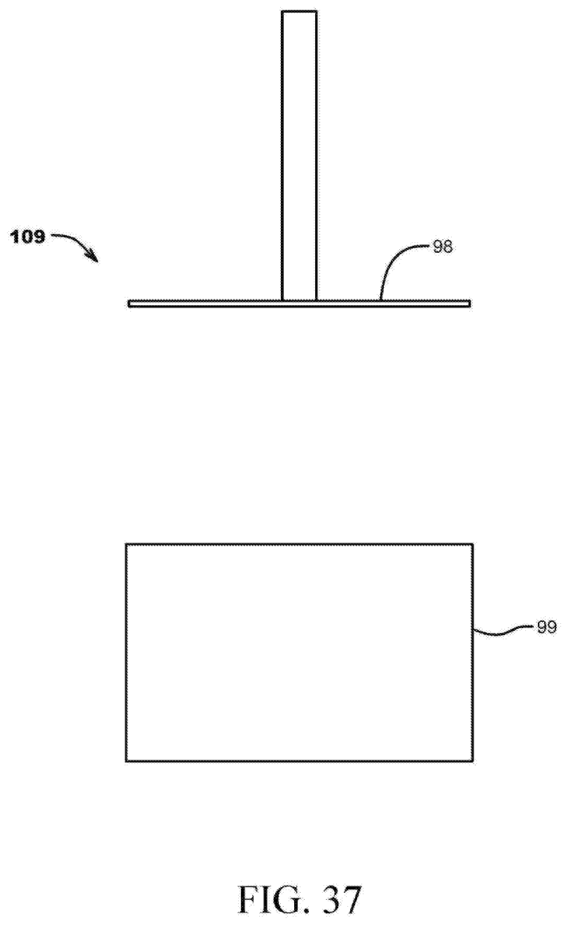

FIG. 36 is a perspective view an extrusion mold/die press system used to form the flexible inline pilaster type column candle wick, according to one embodiment of the present invention. FIG. 37 is a front view of one design variation of an extrusion mold/die press system used to form the flexible inline pilaster type column candle wick, according to one embodiment of the present invention.

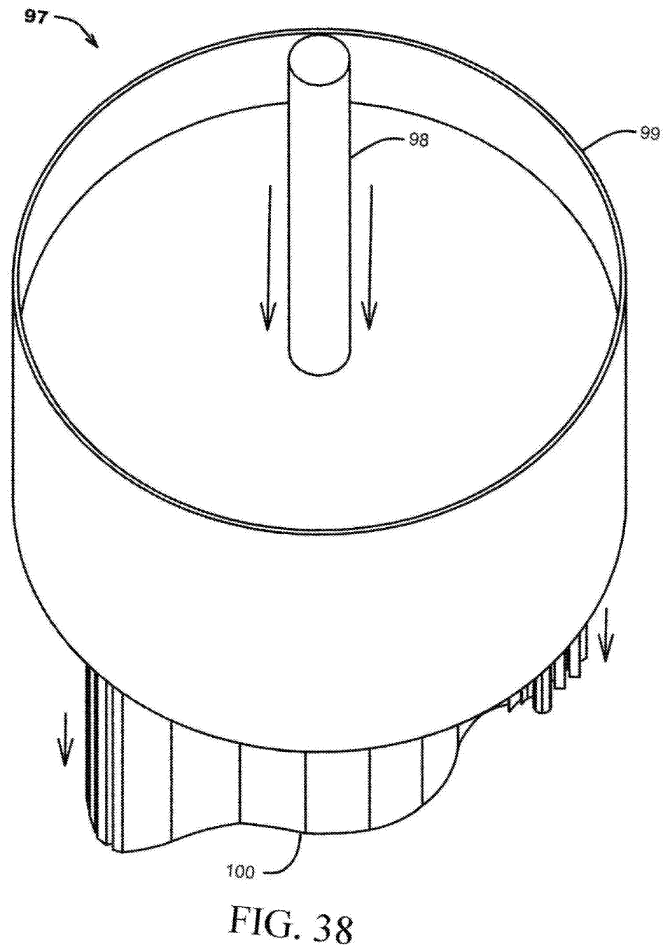

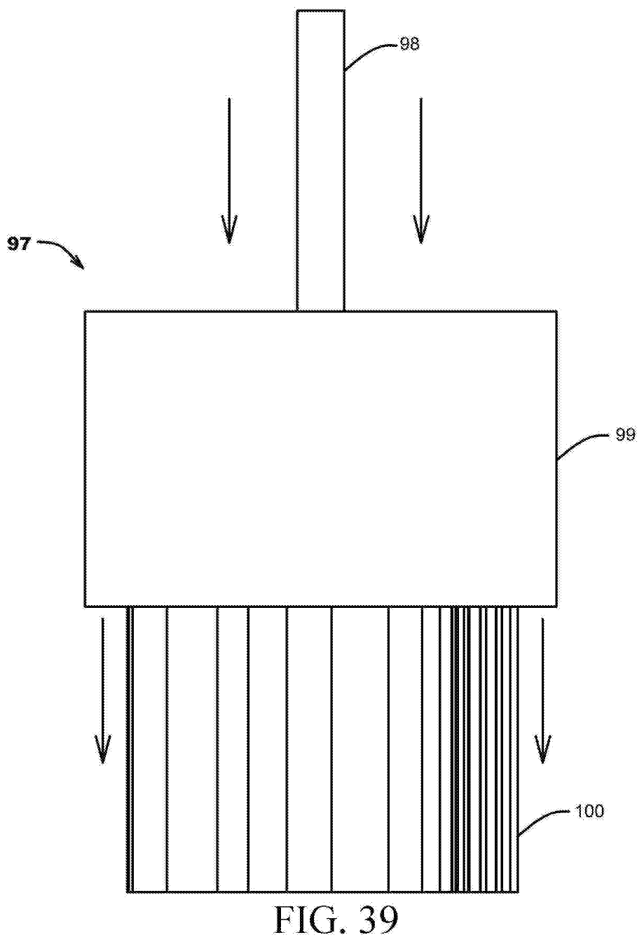

FIG. 38 is a perspective view of one design variation of an extrusion mold/die press system used to form the flexible inline pilaster type column candle wick mixed components are shown being forced through the system, according to one embodiment of the present invention. FIG. 39 is a front view of one design variation of an extrusion mold/die press system used to form the flexible inline pilaster type column candle wick. Mixed components are shown being forced through the extrusion chamber, according to one embodiment of the present invention.

Referring to FIGS. 36-39 is a flexible pilaster wick assembly in an extrusion mold/die press system 109. In one embodiment an extrusion mold/die press, an extrusion press plunger 112 with a press plate 98, and a mold/die chamber 99. The mold/die chamber is used to form candle configuration 107 of the present invention. The extrusion mold/die having a plunger 112 with an extrusive plate 98 is used with a mold chamber 99 to press and extrude the flexible candle configuration 107 out of the mold/die chamber 99. The shape of the flexible pilaster wick 77 may include but is not limited to rectangular, oval, circular, or any custom/decoration shape.

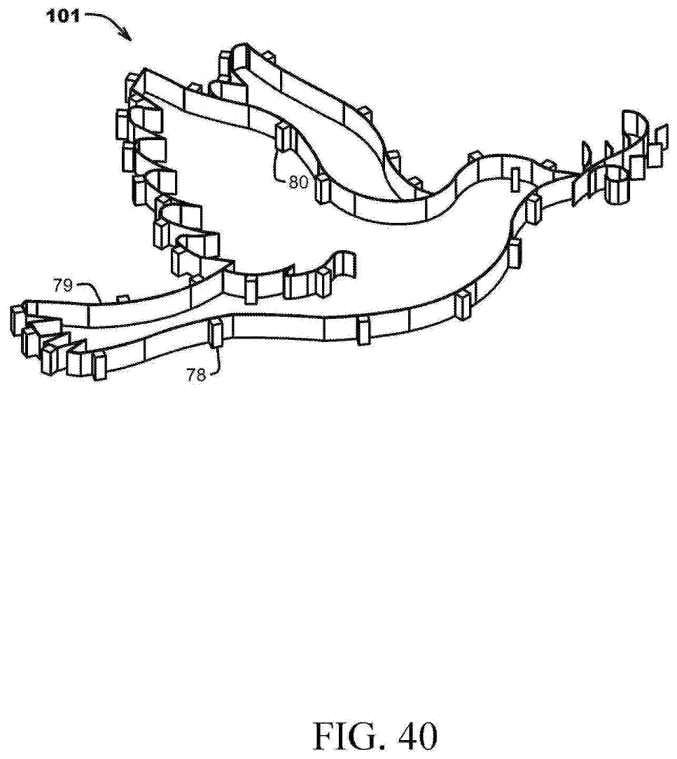

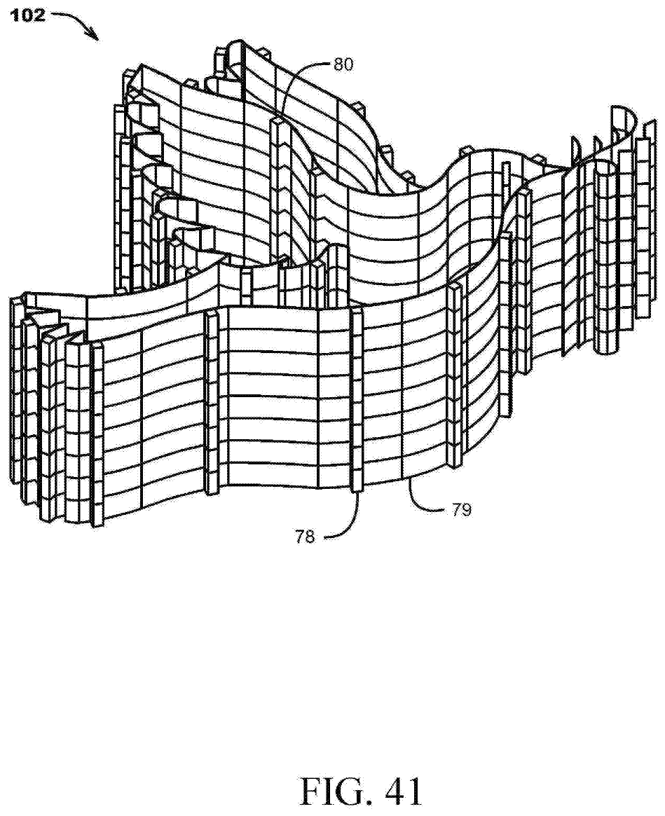

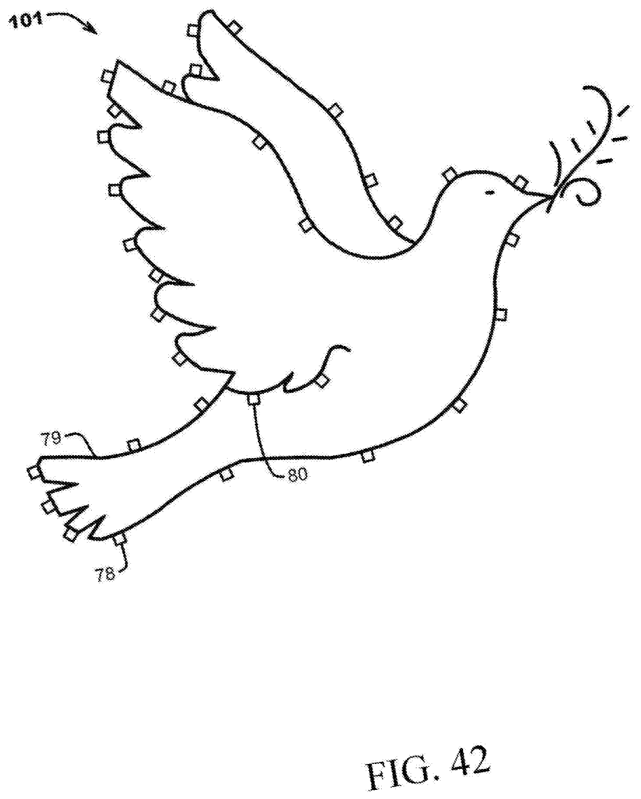

FIG. 40 is a perspective view of one design variation of an extruded multifariously shaped single-stacked mold 101 of the flexible inline pilaster type column candle wick, according to one embodiment of the present invention. FIG. 41 is a perspective view of the design variation of FIG. 40 depicting multiple-stacked layers 102 of the multifarious mold of the flexible inline pilaster type column candle wick. FIG. 42 is a top view of the extruded multifarious molds 101 and 102 of the flexible inline pilaster type column candle wick of FIG. 41.

Referring to FIGS. 40-42, a single-layer flexible pilaster wick assembly 101 formed through the extrusion mold/die press system described above is provided including first layer 78, second layer wick body 79, and the third pilaster layer 80. In FIG. 41 the single-stacked mold 101 is stacked to form a built up or deeper multiple-stacked mold 102. FIG. 42 depicts a top view of the stacked molds 101 and 102 of FIG. 41. The flexible pilaster wick showing wick body 79 with pilaster layers 78 and 80 embedded may be extrusion molded into a multifarious shape including, but not limited to rectangular, oval, circular, or any complex custom/decoration shape.

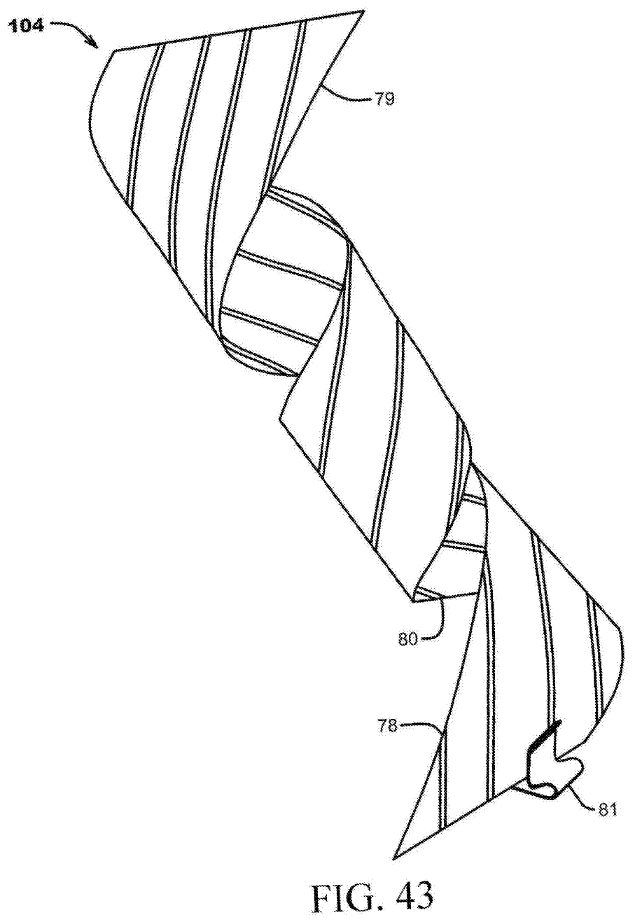

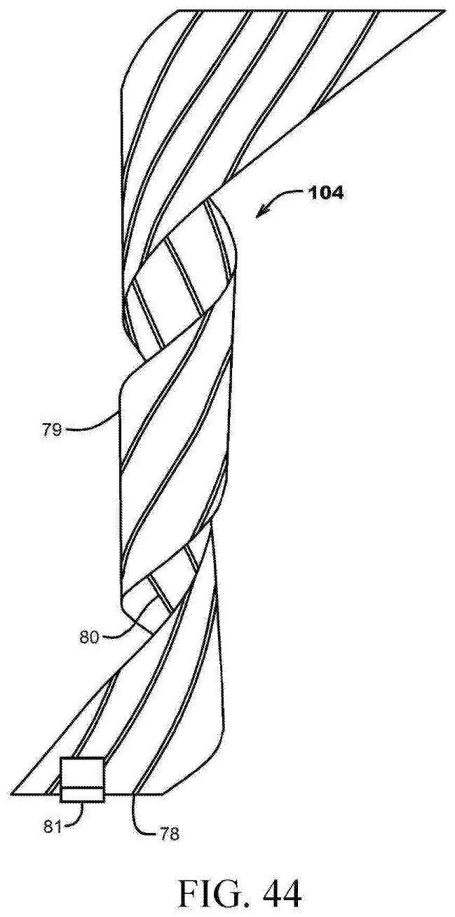

FIG. 43 is a perspective view of a spiral design of a flexible inline pilaster type column candle wick 104 depicted in a twisted position, according to an embodiment of the present invention. FIG. 44 is a rotated view of a spiral design of the flexible inline pilaster type column candle wick 104 of FIG. 43.

Referring to FIGS. 43 and 44, in one embodiment, a single-layer flexible pilaster wick assembly 104 may be provided and twisted into a spiral shape that includes first pilaster layer 78, second wick body layer 79, and third pilaster layer 80. The wick assembly 104 may be secured by retainer clip 81. Wick assembly 104 may be used in a container with wax/fuel surrounding the wick assembly 104 and filling the container.

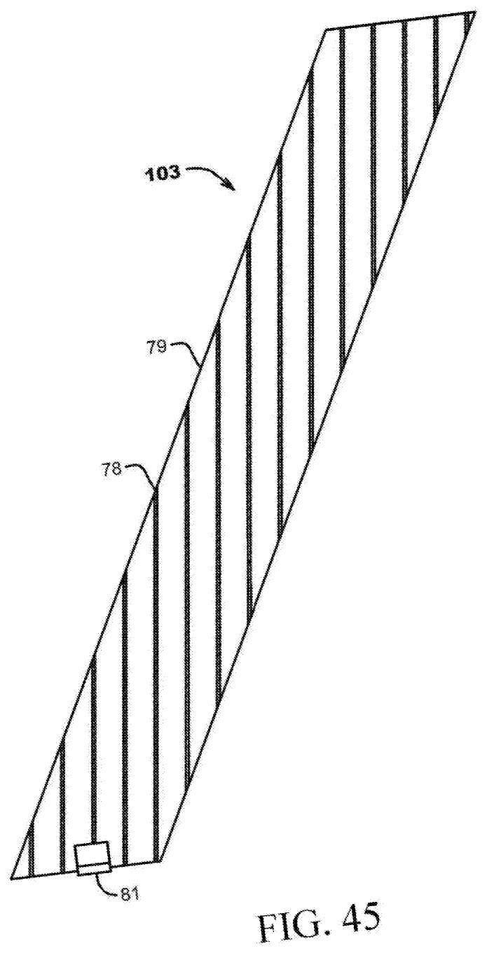

FIG. 45 is a front view of the spiral design of the flexible inline pilaster type column candle wick assembly 103 depicted in a flat, or otherwise untwisted position. Referring to FIG. 45, yet another embodiment of the present invention includes a single-layer flexible pilaster wick assembly 103 depicted in a planer shape, including the first pilaster layer 78, and the second wick body layer 79. In this view a pilaster layer 80 is not referenced; however, there may be two pilaster layers or a single pilaster layer without departing from the spirit and scope of the invention. Retainer clip 81 is also depicted in this embodiment. In this embodiment, the planer single-layer flexible pilaster wick assembly 103 may be used in a container such as container 85 with wax/fuel 83 of FIG. 24 surrounding the wick and filling the container.

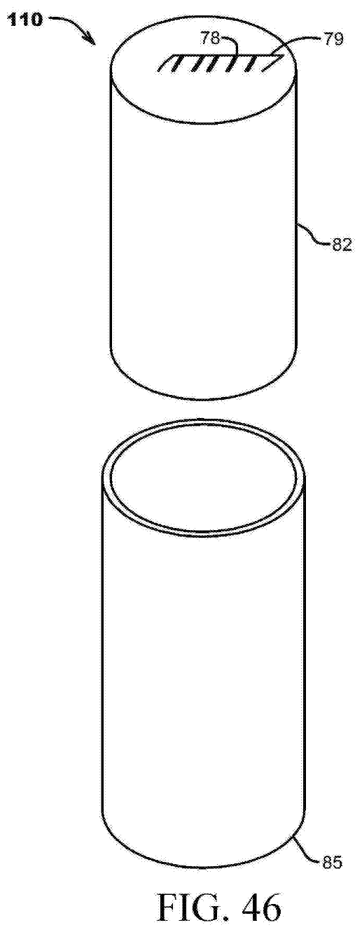

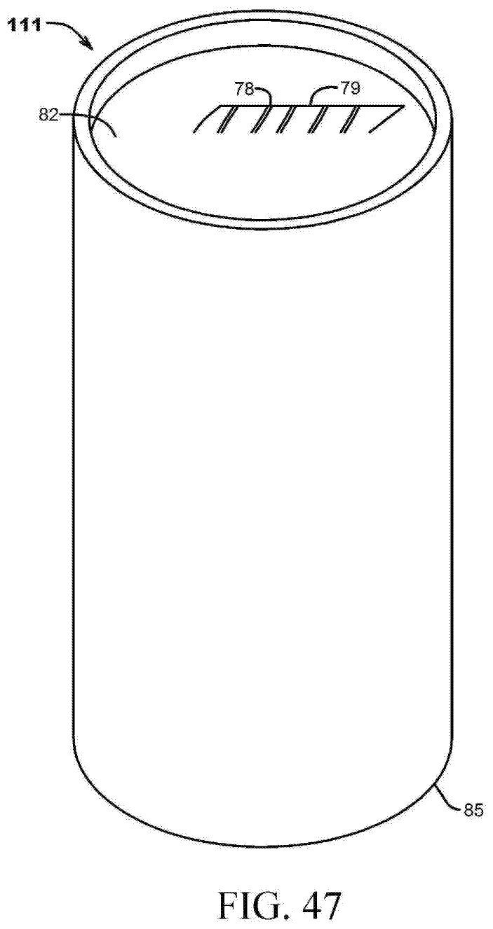

FIG. 46 is a perspective view of a spiral design of the flexible inline pilaster type column candle wick 110 depicted in either a flat or untwisted or twisted position surrounded by wax/fuel, outside of container, according to one embodiment of the present invention. FIG. 47 is an isometric perspective view of a spiral design of the flexible inline pilaster type column candle wick assembly 110 depicted in either an open/flat/untwisted or twisted position, surrounded by wax/fuel 83, inside of container 85, according to an embodiment of the present disclosure.

Referring now to FIGS. 46 and 47, the planer and spiral embodiments of the pilaster wick candle assembly 110 with wax/fuel 82 surrounding the wick comprised but not limited to wick body 79 and pilaster layer 78. In one embodiment the candle assembly 110 matches the inner shape of the candle container 85 dimensionally and may be placed therein by a user. In the present invention, the planer and/or spiral single-layer flexible pilaster wick comprised but not limited to wick body 79 and pilaster layer 78, can be used in a container 85 which includes, but not limited to, square, rectangular, oval, cylindrical, or any complex custom/decoration shape. The candle 110 is produced when placed within candle container 85.

### Materials:

The first and second pilaster layers and the wick body may be fabricated or sourced of organic materials not limited to, in any arrangement, in any sequence, or in any part or whole cotton paper, cotton muslin, cotton thread, silk thread, silk gauze, wool, wood, cellulose, organic batting, organic woven material, and organic glue. Additional materials may be added in part or whole including, but not limited to, nut or nut related species in relation to genus exocarp, mesocarp, or endocarp (pericarp family); corylus americana, carya illinoensis, arachis hypogea, macadamia integrifolia, prunus amygdalus, bertholletia excelsa, castanea dentata, aleurites molucanna, trapa bicornis, or juglans regia.

In one embodiment, fruit or fruit related materials may be added in part or whole including, but not limited to, species in relation to the endosperm, embryo, seed coat (seed family), exocarp, mesocarp, or endocarp (pericarp family); Pyrus malus, Prunus armeniaca, Persea americana, Musa paradisicum, Rubus fruticosus, Ribes nigrum, Vaccinium cyanococcus, Solanum melongena, Cucumis melo, Capsicum fruitscence, Daucas carota, Anacardium occidentale, Prunus avium, Capsicum annuum, Syzygium aromaticum, Cocos nucifera, Coriandrum sativum, Cucumis sativas, Phoenix dactylifera, Hylocereus undutus, Solanum melongena, Ficus carica, Allium sativum, Ribes uva-crispa, Vitis vinifera, Psidium guava, Cucumis melo, Artocarpus integra, Actinidia deliciosa, Citrus limonium, Lactuca sativa, Citrus latifolia, Litchi chinensis, Citrus reticulata, Mangifera indica, genus: Morus, Prunus persica, Allium cepa, Citrus aurantium, Carica papaya, Passiflora edulis, Pisum sativam, Pyrus communis, Ficus religiosa linn, Diospyros kaki, Ananus sativus, Prunus domestica, Punica granatum, Solanum tubersum, Opuntia stricta, Santalum acuminatum, Cydonia oblonga, Raphanus sativus, Rubus idaeobatus, Ribes rubrum, Spinacia oleracea, Averrhoa carambola, Lycopersican esculentum, Curcuma longa, and Citrullus vulgaris.

The first pilaster layer, wick body, and second pilaster layer of the single-layer wick embodiment may be bonded with spray adhesive, non-toxic glue, pup bond, or any other suitable non-toxic bonding materials. Additionally, the layers can be assembled by using traditional sewing methods. Further, multiple layers of the present invention can be bonded with spray adhesive, non-toxic glue, pup bond, or any other suitable non-toxic bonding materials, and/or by using traditional sewing methods.

To adjust the candle flame height for controlling a hotter or a cooler burn, the user/manufacturer may conveniently set the spacing between the parallel pilasters across the second wick body layer of the present invention to a desired flame height. The pilaster spacing can be set from 1/128 inch to 12 inches. When the pilaster spacing is nearest 1/128 inch, the flame height is higher than ¼ inch, while the flame height is lower than ¼ inch when the pilaster spacing is nearest 12 inches. The fuel used in the present invention for the container candle and or free-standing candle includes, but is not limited to, wax, butane gas, propane gas, and other suitable fuels. The present invention may include scented oil, perfumes, or incense in one embodiment for the purpose of releasing fragrance when heated.

It will be apparent with skill in the art that the flexible inline pilaster wick of the present invention may be provided using some or all the elements described herein. The arrangement of elements and functionality thereof relative to the pilaster wick of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A candle wick comprising:
at least a first layer of pilasters; and
a second layer of soft body wick material, the first layer of pilasters adhered or otherwise attached to the wick body, the pilasters parallel, spaced apart, and attached or adhered orthogonally to the longitudinal axis of the wick body.

2. The candle wick of claim 1 further including a third pilaster layer opposing the first pilaster layer on the side of the wick body layer opposite the first layer of pilasters, wherein the individual pilasters are spaced in matching patterns.

3. The candle wick of claim 1 or 2, wherein the method of attachment of the layers together is bonding and the bonding material is one or a combination of a spray adhesive, non-toxic glue, pup bond material.

4. The candle wick of claim 1 or 2, wherein the wick is molded with wax and used with or without a candle container.

5. The candle wick of claim 1 or 2, wherein the wick is a single layer wick having only one wick body.

6. The candle wick of claim 1 or 2, wherein the wick is molded and stacked forming a multiple layered candle wick.

7. The candle wick of claim 1 or 2, wherein the wick includes a retainer clip to aid in positioning.

8. The candle wick of claim 1 or 2, wherein the spacing of the pilasters is set during manufacture of the wick to be as small as one and one hundred twenty eighth of an inch to as large as 12 inches between the pilasters in a layer of pilasters.

9. The candle wick of claim 1 or 2, wherein the wick is flexible to form radii, corners, circles, ovals, ellipses, rectangles, squares, and multifarious shapes.

10. The candle wick of claim 9, wherein the fuel for the wick is wax and the wax has a same outer shape as the wick assembly.

11. The candle wick of claim 1 or 2, wherein the wick is formed in a spiral and clipped within a container.

12. The candle wick of claim 1 or 2, wherein the fuel for the wick is one of butane gas, propane gas, or scented oil.

13. The candle wick of claim 1 or 2, wherein the pilasters may be length adjusted to extend past the edge or edges of the wick body a desired amount.

14. The candle wick of claim 1 or 2, wherein the pilasters are rectangular and may include pilasters of varying widths and depths.

15. The candle wick of claim 1 or 2, wherein the pilaster spacing along the side of the wick body may be varied greatly wherein closer spacing produces a brighter flame at a higher flame height and more sparse spacing produces a less bright flame at a lower height.

16. The candle wick of claim 1 or 2, wherein the plasters and or the wick body are manufactured from one or a combination of cotton paper, cotton muslin, cotton thread, silk thread, silk gauze, wool, wood, cellulose, organic batting, organic woven material, and organic glue.

17. The candle wick of claim 1 or 2, wherein the pilasters and or the wick body are manufactured from one or a combination of organic nut species and or one or a combination of organic fruit species.
